(19) United States
(12) Patent Application Publication
(10) Pub. No.: US 2026/0135408 A1
(43) Pub. Date: May 14, 2026

(54) GROUPING OF ELECTRICAL SOCKETS

(71) Applicant: Honeywell International Inc., Charlotte, NC (US)

(72) Inventors: Deepthi Sethuraman, Bangalore (IN); Scott Yetter, Philadelphia, PA (US)

(21) Appl. No.: 18/942,795

(22) Filed: Nov. 11, 2024

(51) Int. Cl. H02J 13/00

(52) U.S. Cl. CPC H02J 13/38; H02J 13/12

(57) ABSTRACT

Examples techniques of grouping of electrical sockets are described. At a building management system (BMS), timestamp information from a plurality of electrical sockets installed within the premises is received. The timestamp information is indicative of a time instance of actuation of the respective electrical sockets. The timestamp information of each of the electrical sockets is compared to each other to identify two or more electrical sockets that are actuated within a predetermined time lapse with respect to each other. Electrical sockets that are to be configured as a group are determined. The electrical sockets of the group are controllable by a common electrical circuit. The BMS records a configuration of the group, including identifications of the electrical sockets of the group and their corresponding zones.

### BACKGROUND

Premises, ranging from residential buildings to large-scale facilities like hospitals, offices, and industrial complexes, typically house numerous assets essential to their functionality and the activities conducted within such premises. These assets may include, but are not limited to, components of heating, ventilating, and air conditioning (HVAC) systems, security and access control equipment, lighting infrastructure, and various office appliances. Examples of such appliances may include copy machines, fans, refrigerators, air conditioners, scanners, facsimile machines, coffee makers, dishwashers, and vending machines, among others. To function, these diverse assets require electrical power, which is commonly supplied by connecting the assets to one or more electrical sockets within the premises.

With increasing environmental awareness and rising power costs, optimizing electricity usage has become crucial for both mitigating environmental impact and managing operational expenses. In this context, monitoring and controlling plug load consumption in the premises through the electrical sockets has gained significant importance. Plug load encompasses the power consumed by devices and equipment connected to the electrical sockets, which may account for a substantial portion of the total power consumption of a building. Effective management of plug loads extends beyond mere power consumption monitoring. Effective plug load management may also involve tracking safety parameters, such as temperature at the electrical sockets, as excessive heat generation may indicate potential safety hazards, power inefficiencies, or malfunctioning equipment. By monitoring both power consumption and temperature, premises managers may enhance power efficiency, reduce costs, improve the overall safety of the assets installed in the premises, and also predict and prevent asset failures. Furthermore, this monitoring may enable more precise power allocation, facilitate the identification of power-intensive areas or equipment, and support data-driven decision-making for power conservation strategies and asset upgrades.

### SUMMARY

The details of some embodiments of the invention described in this specification are set forth in the accompanying drawings and the description below. Other features, aspects, and advantages of the invention will become apparent from the description, the drawings, and the claims.

The present invention relates to methods, systems, and non-transitory computer-readable media for grouping of electrical sockets installed in a premises.

According to an aspect of the present invention, a method for grouping electrical sockets installed in a premises includes receiving, at a server communicatively coupled to a plurality of electrical sockets located in one or more zones within the premises, timestamp information from the plurality of electrical sockets. The timestamp information is indicative of a time instance of actuation of the respective electrical sockets. The method further includes comparing the timestamp information of each of the electrical sockets to each other to identify two or more electrical sockets that are actuated within a predetermined time lapse with respect to each other. Furthermore, the method includes determining the identified electrical sockets to be configured as a group. In an example, the electrical sockets of the group are connected to a common electrical circuit. The method further includes recording, at the server, a configuration of the group in an example. The configuration of the group includes an indication of each of the electrical sockets identified to be in the group along with a zone corresponding to each of the identified electrical sockets of the group.

In accordance with an embodiment of the present invention, the system for grouping electrical sockets installed in a premises includes a processor that is configured to receive timestamp information from a plurality of electrical sockets located in one or more zones within the premises. The timestamp information is indicative of a time instance of actuation of the respective electrical sockets. The processor is further configured to compare the timestamp information of each of the plurality of electrical sockets to identify two or more electrical sockets that are actuated within a predetermined time lapse with respect to each other. The processor determines the identified two or more electrical sockets to be configured as a group. In an example, each of the two or more electrical sockets of the group is controllable by a common electrical circuit. The processor records a configuration of the group, the configuration including an indication of each of the electrical sockets identified to be in the group along with a zone corresponding to each of the identified electrical sockets of the group. The processor further monitors at least one of power consumption and temperature of each electrical socket of the group.

In accordance with an embodiment of the present invention, the non-transitory computer-readable medium contains instructions that enable a processing resource to receive timestamp information from a plurality of electrical sockets located in one or more zones within the premises. In an example, the timestamp information is indicative of a time instance of actuation of the respective electrical sockets. The processing resource is to further compare the timestamp information of each of the plurality of electrical sockets to identify two or more electrical sockets that are actuated within a predetermined time lapse with respect to each other. Furthermore, the processing resource is to determine the identified two or more electrical sockets to be configured as a group. In an example, each of the two or more electrical sockets of the group is controllable by a common electrical circuit. The processing resource further records a configuration of the group. In an example, the configuration includes an indication of each of the electrical sockets identified to be in the group along with a zone corresponding to each of the identified electrical sockets of the group. In an example, the processing resource is to also create sub-groups within the group, each sub-group including a subset of the electrical sockets in the group that are located in the zone.

Embodiments of the present invention provide for automatic identification of the electrical sockets on the same circuit without requiring manual tracing and without referring to complex wiring diagrams. This may be useful in large premises where the electrical layout may be complex or poorly documented. The present subject matter facilitates the correct identification of the electrical sockets connected to a common circuit by examining their activation timestamps, substantially decreasing the time and resources typically needed for circuit mapping procedures.

Additionally, this approach is non-invasive and does not require any physical modifications to existing electrical infrastructure of the premises. The technique of the present subject matter may be implemented using smart sockets or plug-load monitors, making it a cost-effective solution for retrofitting existing buildings with smart power management capabilities. The automated grouping of the electrical sockets of the premises also enables more effective power management and monitoring. By accurately identifying which electrical sockets are on the same circuit, a building operations management system may be used to prevent overloading, optimize power distribution, and provide more granular power consumption data. This may lead to improved power efficiency, reduced operational costs, and enhanced safety in the electrical infrastructure of the premises.

Additional features and advantages are realized through the concepts of the present invention. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for grouping of electrical sockets installed in a premises, in accordance with an example implementation of the present subject matter.

FIG. 2 illustrates a system for grouping of the electrical sockets installed in the premises, in accordance with an example implementation of the present subject matter.

FIG. 3 illustrates the system for grouping of the electrical sockets installed in the premises, in accordance with another example implementation of the present subject matter.

FIG. 4 illustrates an exemplary representation of sub-grouping of the electrical sockets, in accordance with an example implementation of the present subject matter.

FIG. 5 illustrates signal flow in a process of grouping of the electrical sockets, in accordance with an example implementation of the present subject matter.

FIG. 6 illustrates a method for grouping of the electrical sockets, in accordance with an example implementation of the present invention.

FIG. 7 illustrates a flow diagram of a process for displaying a visual representation of a configuration of a group of electrical sockets, according to an example implementation of the present subject matter.

FIG. 8 illustrates a flow diagram of a process of monitoring the group of electrical sockets, according to an example implementation of the present subject matter.

FIG. 9 illustrates a computing environment for grouping the electrical sockets, according to an example implementation of the present invention.

In the figures, the left-most digits of a reference number identify the figure in which the reference number first appears. The same numbers are used throughout the drawings to reference like features and components.

### DETAILED DESCRIPTION

Modern premises, from residential homes to expansive commercial complexes and industrial facilities, house a wide array of equipment essential for their operation. This equipment may include lighting systems, heating and cooling units, security devices, communication networks, electronic devices, and various appliances. At the heart of power distribution systems that enable the delivery of electrical power within such premises are electrical sockets, which serve as a primary interface between the electrical infrastructure of the premises and the diverse devices and appliances that drive daily operations. These electrical sockets, often overlooked, play a crucial role in shaping electricity usage within the premises.

In recent years, the impact of power consumption from devices and appliances plugged into the electrical sockets has gained significant attention. This type of power usage, often referred to as “plug load,” has become a focal point for power management strategies in various types of premises. The plug load may account for a substantial portion of total power consumption in the premises. Common sources of the plug load in the premises may include, but are not limited to, equipments such as computers, monitors, printers, and copiers; kitchen appliances like refrigerators, microwaves, air conditioners, and coffee makers; and entertainment devices such as televisions and gaming consoles. In commercial settings, vending machines, water coolers, and specialized equipment may also contribute significantly to the plug load.

The challenge of managing plug load-based power consumption is compounded by changing patterns of premises usage. For instance, occupancy of a premises may vary significantly over a day, week, or season, leading to scenarios where power continues to be consumed even when spaces are vacant. For example, in an office premises where employees work remotely three days a week, computers, printers, and other equipment contributing to plug load continue to draw power during those unoccupied days. Similarly, conference room projectors, lobby televisions, and vending machines may remain operational 24/7, despite being used only during business hours. This may result in unnecessary power waste and inflated power bills.

Furthermore, the proliferation of electronic devices in both work and living spaces has intensified the impact of the electrical socket-based power consumption. Many of these devices draw power even when not in active use, contributing to what is known as a “standby” or “vampire” power drain. This constant, low-level power consumption may accumulate significantly over time, particularly in large premises with hundreds or thousands of connected devices.

The complexity of assets installed in modern premises and the large number of electrical sockets in use present significant challenges for facility managers and power conservation efforts. Traditional approaches to power management often lack the granularity needed to effectively monitor and control power consumption at a level of individual electrical sockets. This gap in oversight may lead to missed opportunities for power savings and difficulty in identifying specific areas of inefficiency or waste.

Smart electrical sockets are often considered a solution for managing power consumption in the premises. These smart electrical sockets may enable monitoring of power usage, provide control for connected appliances remotely, and may even provide detailed consumption data. By leveraging the smart electrical sockets, facility managers may gain valuable insights into occupancy hours and power usage patterns and implement more effective conservation strategies.

However, managing individual smart electrical sockets across large premises, such as a large office complex, presents its own set of challenges. With potentially hundreds or thousands of the electrical sockets in a single facility, monitoring and controlling each one separately may be time-consuming and impractical.

To address this issue, a common practice is to group the electrical sockets according to zones or functions within a premises. This approach allows for more streamlined management and analysis of power consumption. For example, all the electrical sockets belonging to an electrical circuit in a particular department or those serving a specific purpose (e.g., powering IT equipment) may be grouped together. This grouping strategy enables facility managers to benchmark power utilization for different areas, track power usage trends, and implement targeted power-saving measures.

Grouping of the electrical sockets also facilitates the implementation of schedules and events for specific zones. For example, all the electrical sockets in an office area may be programmed to power down outside of business hours, while those in critical areas, such as server room, remain active. This level of control helps optimize power use based on actual occupancy and operational needs, potentially leading to significant power savings. Furthermore, the grouping of the electrical sockets also allows for more meaningful comparisons and analyses. The facility managers may easily compare power consumption between different departments, floors, or functional areas. This information may be used for identifying areas of high consumption, spotting anomalies, and making data-driven decisions about power conservation efforts.

Additionally, grouping of electrical sockets may help track power consumption in the premises more effectively. By grouping the electrical sockets that belong to a common electrical circuit, facility managers may monitor the power draw and temperature of the devices connected to that electrical circuit. This correlation may enable more precise control of power usage and identify electrical circuits and electrical sockets with higher temperatures and/or increased power consumption. Such insights may help in improving overall power efficiency and identifying issues such as overheating equipment or overloaded electrical circuits.

Despite these advantages, conventional methods for grouping the electrical sockets come with their own set of challenges. Typically, these groups are manually configured. For example, facility managers may need to physically trace wiring or consult electrical diagrams, if available, to determine which electrical sockets are on the same circuit. The manual grouping of the electrical sockets may be a time-consuming and error-prone process. After the initial installation of electrical sockets, facility managers or technicians may be required to remember the location of each electrical socket, identify which electrical circuit the electrical socket belongs to, and manually assign the electrical socket to the appropriate group. This process often requires additional effort during the commissioning phase or whenever changes are made to the layout or function of the premises. Moreover, as buildings undergo renovations or reconfigurations over time, maintaining accurate groupings becomes increasingly challenging, potentially leading to outdated or incorrect grouping of the electrical sockets. This may result in inaccurate power monitoring and ineffective control strategies.

According to example implementations of the present invention, techniques for grouping of electrical sockets that may allow for automatic identification of electrical circuit connections and efficient organization of the electrical sockets with minimal human interaction are described.

In accordance with example embodiments of the present subject matter, a system for grouping electrical sockets enables recording of timestamp information based on which the electrical sockets may be automatically assigned to groups. The system may receive timestamp information indicating when each electrical socket is actuated, compare this information, and group sockets that are actuated within a predefined time-lapse as belonging to the same electrical circuit. This approach may significantly reduce the manual effort required in grouping of the electrical sockets and improve the accuracy of circuit identification in premises. By utilizing the temporal relationship of electrical sockets actuation, the system may efficiently and reliably group the electrical sockets without relying on assumptions or manual intervention.

In an example embodiment, to form a group of the electrical sockets, the system receives timestamp information from a plurality of electrical sockets located in one or more zones within the premises. In an example, the timestamp information may be indicative of a time instance when the respective electrical sockets become energized or operational. In an example, each of the plurality of electrical sockets may be communicatively coupled to the system, for example, through a hub or gateway, transmitting the timestamp information to the system when each electrical socket is actuated.

In an embodiment, after receiving the timestamp information from the plurality of electrical sockets, the system compares the timestamp information of each of the plurality of electrical sockets to identify two or more electrical sockets that are actuated within a predetermined time lapse with respect to each other. In an example, the predetermined time lapse may be a configurable parameter and may be set based on factors such as the typical delay between circuit breaker activation and socket power-up, or the expected variation in power-up times for the electrical sockets belonging to an electrical circuit. The system may use this predetermined time lapse as a tolerance window when comparing timestamp information to determine which electrical sockets are to be grouped together.

In an example embodiment, based on the comparison of the time stamp information, the system identifies the two or more electrical sockets as belonging to a group. In an example, each of the two or more electrical sockets of the group is controllable by a common electrical circuit. In other words, the system infers that the electrical sockets actuated within a specified time frame are likely connected to the same electrical circuit. This grouping method leverages the fact that when a circuit breaker is activated, all sockets on that electrical circuit typically become energized within a short time span.

In an example embodiment, the system records a configuration of the group. In an example, the configuration may include an indication of each of the electrical sockets identified to be in the group along with a zone corresponding to each of the identified electrical sockets of the group. This configuration may provide a clear mapping of which electrical sockets are connected to the same electrical circuit and their physical distribution across the premises, enabling easier management, troubleshooting, and targeted power control.

The present invention, thus, by automatically grouping the electrical sockets and monitoring their power consumption, achieves efficient circuit management without compromising building safety or requiring extensive manual configuration. These pre-built groups streamline the monitoring process, eliminating the need for manual configuration while still allowing the facility manager to create sub-groups as needed. The remote server monitors each circuit group and generates an alarm if the power consumption exceeds a predetermined threshold, enabling prompt response to potential overload situations. This approach ensures accurate power usage tracking while providing flexibility for customized monitoring of different areas within the premises.

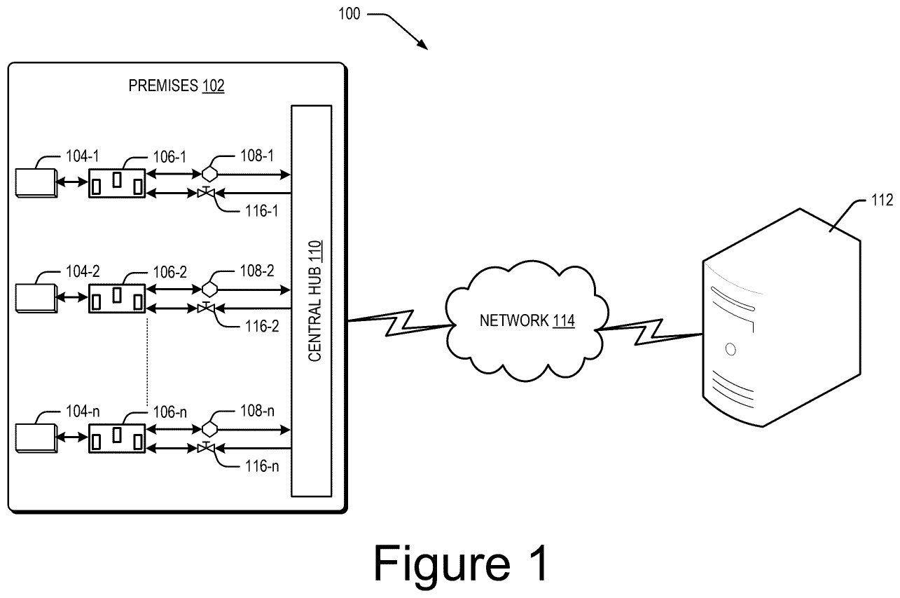

The above techniques are further described with reference to FIG. 1 to FIG. 8. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing examples techniques for grouping of electrical sockets, in accordance with an example implementation of the present invention.

Various operations are carried out in premises, such as commercial offices, industrial facilities, malls, hotels, hospitals, residential complexes, or educational institutions, in accordance with various standard operating procedures (SOPs) predefined for the premises for different purposes, often, to support occupant needs while also addressing additional requirements, such as cost-efficient and sustainable operation of the premises. As the premises are designed for a wide variety of purposes, the SOPs for the premises vary significantly to cater to the respective purposes. For example, an SOP of a premises designed to serve as a cold storage may vary significantly from that designed to serve as a movie theater.

In accordance with the purpose of a premises 102, one or more assets 104-1, 104-2, . . . , and 104-N that are controlled by the actuation of corresponding electrical sockets 106-1, 106-2, . . . , and 106-N are installed in the premises 102 to achieve the same. Referring to the previous example, assets such as cooling equipment may be installed in the cold storage while speakers and display screens may be installed in the movie theater. The assets 104-1, 104-2, . . . , and 104-N within the premises 102 are operated with the help of corresponding electrical sockets 106-1, 106-2, . . . , and 106-N individually and/or in conjunction with each other in accordance with predefined SOPs that are designed to serve the purpose of the premises 102.

In an embodiment, an SOP of the premises 102 may refer to a process that is implemented for the proper functioning, maintenance, or management of the premises 102. For example, in the context of an office building, the SOPs may be defined in accordance with the requirements and comfort of the occupants while optimizing power usage. For example, an SOP may dictate keeping lighting fixtures in working areas ‘on’ during office hours and ‘off’ after office hours. Another SOP may require keeping lighting fixtures in pantry areas ‘off’ during work hours and ‘on’ during lunch hours. In parking areas of the office building, an SOP may be to keep lighting fixtures ‘off’ when there is no movement and to turn ‘on’ during the movement of people or vehicles. These SOPs may be defined to enhance occupant comfort, ensure safety, and optimize power consumption based on actual usage patterns and needs within different areas of the premises 102.

In an embodiment, an asset, such as the asset 104-1, may refer to any physical device, system, piece of equipment, or collection of equipment that may be controlled, for example, through actuation of a corresponding electrical socket, such as the electrical socket 106-1, to cause the asset to operate according to one or more SOPs predefined for a premises, such as the premises 102. An asset, for example, maybe a single lighting fixture, a group of lighting fixtures in a particular area of the premises 102, or an entire lighting system. The term “asset” may also extend to other devices and systems within the premises 102. For example, the asset may include office equipment like printers, copiers, and computers; kitchen appliances such as coffee makers, microwaves, and refrigerators; or convenience devices like vending machines and water coolers. In some cases, an asset may be a more complex system, such as an electric vehicle charging station or a set of networked devices, where operations of multiple components are controlled, for example, through actuation of their corresponding electrical sockets, to achieve adherence to a unified SOP within the premises 102.

In an embodiment, an electrical socket, such as the electrical socket 106-1, may refer to any physical outlet or connection point that may supply electrical power to an asset, such as the asset 104-1, within the premises 102. An electrical socket may be a standard wall outlet, a smart plug, a power strip, or a specialized power distribution device. The electrical socket 106-1 may be capable of controlling the flow of power to the connected asset, such as turning the power on or off, regulating voltage, or monitoring current draw. In some cases, an electrical socket may be a simple on/off switch, while in others, the electrical socket may be a more sophisticated device with built-in sensors and communication capabilities. For example, the electrical socket may include features for measuring power consumption, monitoring temperature at the electrical socket, detecting plugged-in assets, and memory for storing readings or communicating with external systems. The term “electrical socket” may also extend to include power management devices that control multiple outlets or even entire circuits within the premises 102. In more complex setups, an electrical socket may be part of a networked system of power distribution, where multiple electrical sockets work in concert to manage power delivery across various assets according to predefined SOPs for the premises 102.

In an embodiment, the predefined SOPs for the premises 102 may affect the operation of the assets 104-1, 104-2, . . . , and 104-N located within the premises 102. For example, in an office building, a predefined SOP may require maintaining a printer in a ready state during working hours. This may be achieved by controlling power supply to the printer through electrical sockets, such as the electrical socket 106-1. The power supply through the electrical socket 106-1 to the printer may be regulated to turn ‘on’ the printer at a predetermined time before workday begins, allowing the printer to warm up and be fully operational when employees arrive. Throughout the day, the power supply through the electrical socket 106-1 to the printer may be regulated in such a manner that the printer remains active and ready for use, aligning with the needs and work patterns of the occupants of the office building.

Another example of an SOP may be to manage the power supply to an asset through an electrical socket to which the asset is connected based on operating temperature or fault status of the electrical socket. For example, if an electrical socket begins to overheat, for instance, due to a loose connection, excessive current draw, or faulty wiring, the SOP may require halting the power supply through the electrical socket to allow the electrical socket to cool down, thus preventing damage to the connected asset. Similarly, if the electrical socket shows signs of malfunction or enters a fault state, the SOP may include cutting off the power supply to the socket to prevent further issues or safety hazards. Such SOPs may be defined to ensure that the electrical sockets 106-1, 106-2, . . . , and 106-N that power the assets 104-1, 104-2, . . . , and 104-N are available when required, while also optimizing their operation and power consumption.

Achieving and maintaining the premises 102 to serve its purpose may involve regulating the operation of the electrical sockets 106-1, 106-2, . . . , and 106-N regularly based on changes in factors that influence the predefined SOPs. In an example, the regulation of the operation of the electrical sockets 106-1, 106-2, . . . , and 106-N may refer to a process of monitoring and affecting a change in a state of operation of the electrical sockets 106-1, 106-2, . . . , and 106-N, such as switching on or switching off the electrical sockets 106-1, 106-2, . . . , and 106-N in the premises 102. This regulation is usually done to respond to changes in external environmental conditions, occupancy patterns, and specific requirements of usage of the premises 102 that may cause the electrical sockets 106-1, 106-2, . . . , and 106-N that supply power to the corresponding assets 104-1, 104-2, . . . , and 104-N to not be in sync with the purpose of the premises 102 if the operations of the electrical sockets 106-1, 106-2, . . . , and 106-N are not regulated. For example, the predefined SOPs defined for electrical sockets powering lighting fixtures installed in an office building may be dependent on external environmental conditions, such as weather conditions, and changes in the weather conditions may influence how the operation of these electrical sockets is regulated. Accordingly, a predefined SOP that includes maintaining desired lighting levels in working areas of an office building throughout the day while also reducing power consumption, may involve dynamically adjusting the power supply through the electrical sockets based on weather outside the office building. This may include reducing power or switching off some of the electrical sockets connected to the lighting fixtures during hours when adequate natural light is available, and activating more electrical sockets as daylight diminishes. Additionally, the use of the premises 102 may change over time, for example, the office building generally becomes vacant after office hours, and the predefined SOPs may dictate that the electrical sockets powering assets in non-essential areas are turned off, such as those connected to lighting fixtures, coffee makers, printers, and copiers. The electrical sockets powering HVAC systems may be adjusted to supply power at levels suitable for power-saving settings. Conversely, the electrical sockets powering security systems and emergency lighting may remain active during these off-hours.

In an example, regulating the operations of the electrical sockets 106-1, 106-2, . . . , and 106-N to ensure that the electrical sockets 106-1, 106-2, . . . , and 106-N continue to operate in accordance with the predefined SOPs and remain in sync with the purpose of the premises 102, may involve controlling operating parameters of the electrical sockets 106-1, 106-2, . . . , and 106-N or components thereof.

In an example, the operating parameters of electrical sockets, such as the electrical sockets 106-1, 106-2, . . . , and 106-N, may be understood as measurable attributes of the electrical sockets 106-1, 106-2, . . . , and 106-N that may be controlled, for example, during operation of the electrical sockets 106-1, 106-2, . . . , and 106-N, to control an output of the electrical sockets 106-1, 106-2, . . . , and 106-N. Examples of the operating parameters of the electrical sockets 106-1, 106-2, . . . , and 106-N may include, but are not limited to, operational state, such as an ‘off’ or ‘on’ state of the electrical sockets 106-1, 106-2, . . . , and 106-N, as well as variable parameters, such as voltage, current, and power output associated with the electrical sockets 106-1, 106-2, . . . , and 106-N that may be sensed, for example, by corresponding sensors 108-1, 108-2, . . . . and 108-N. In an example, although the sensors 108-1, 108-2, . . . . and 108-N are depicted separated from the electrical sockets 106-1, 106-2, . . . , and 106-N, in certain cases, such as where the electrical sockets 106-1, 106-2, . . . , and 106-N are smart electrical sockets, the sensors 108-1, 108-2, . . . . and 108-N may be built into the electrical sockets 106-1, 106-2, . . . , and 106-N as explained previously. In such cases, readings from these built-in sensors 108-1, 108-2, . . . . and 108-N may be stored in a memory of the corresponding electrical sockets themselves 106-1, 106-2, . . . , and 106-N. For example, operating parameters of an electrical socket powering a lighting fixture may include an on/off state, power output schedule, voltage regulation settings, current limits, and operating temperature. In an example, the operating parameters of the electrical sockets 106-1, 106-2, . . . , and 106-N may be controlled individually or in combination to achieve desired performance outcomes while adhering to the predefined SOPs and optimizing energy efficiency.

In an embodiment, to address dynamic requirements in achieving and maintaining the intended functionality of the premises 102, central hubs, such as a central hub 110, that enforce the predefined SOPs within the premises 102 may be used.

In an embodiment, the central hub 110 may be implemented to enforce the SOPs predefined for the premises 102, for example, by controlling the operating parameters of the electrical sockets 106-1, 106-2, . . . , and 106-N to ensure the maintenance of a desirable environment within the premises 102 in accordance with the predefined purpose. In an example, each of the plurality of electrical sockets 106-1, 106-2, . . . , and 106-N may be connected through wired or wireless means to the central hub 110, allowing the central hub 110 to monitor and manage the electrical sockets 106-1, 106-2, . . . , and 106-N by controlling values of the operating parameters of the electrical sockets 106-1, 106-2, . . . , and 106-N. For example, the central hub 110 may be used to control the operating parameters of electrical sockets powering various equipment on a floor of an office building as per a predefined SOP. This SOP may include adjusting power output to the electrical sockets based on time of day, occupancy, and natural light availability; switching off electrical sockets connected to non-essential equipment such as coffee makers or vending machines during off-hours; and maintaining minimal power to electrical sockets for essential security systems and emergency lighting, thus optimizing energy usage while meeting operational needs of the premises 102.

The central hub 110 may be any computing device, such as a server, a desktop computer, a laptop, a smartphone, or a tablet. The central hub 110 may comprise one or more processors for executing instructions to control and monitor the operating parameters of the electrical sockets 106-1, 106-2, . . . , and 106-N. In an example, the processor may be implemented as microprocessors, microcomputers, microcontrollers, digital signal processors, central processing units, state machines, logic circuitries, and/or any devices that manipulate signals based on operational instructions. The central hub 110 may comprise a memory for storing the instructions executable by the one or more processors. The instructions may cause the processor to control and monitor the operating parameters of the electrical sockets 106-1, 106-2, . . . , and 106-N, for example, by actuation of the electrical sockets electrical sockets 106-1, 106-2, . . . , and 106-N. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In an embodiment, the sensors 108-1, 108-2, . . . , and 108-N may be connected with the corresponding electrical sockets 106-1, 106-2, . . . , and 106-N and may sense current operating parameters associated with the corresponding electrical socket. The central hub 110 may use the data from the sensors 108-1, 108-2, . . . , and 108-N, which represents a value of the corresponding operating parameters, to monitor and control the operations of the electrical sockets 106-1, 106-2, . . . , and 106-N in accordance with the predefined SOP. For example, referring to the previous example of lighting fixtures connected to an electrical socket, such as the electrical socket 106-1, the corresponding sensor, such as the sensor 108-1, may detect current voltage, current, and power consumption of the electrical socket 106-1, allowing the central hub 110 to adjust these parameters based on occupancy, time of day, or energy efficiency goals set in the predefined SOPs. This adjustment may involve modifying the power output of the electrical socket 106-1 to optimize the energy usage of the connected lighting fixture while maintaining the required functionality of the lighting fixture.

In accordance with example implementations of the present subject matter, the central hub 110 may work in conjunction with a building management system (BMS) 112 to optimize the operation of the electrical sockets 106-1, 106-2, . . . , and 106-N in the premises 102. The BMS 112 may be configured to provide scheduling instructions for adjusting the operating parameters of the electrical sockets 106-1, 106-2, . . . , and 106-N housed in the premises 102 for achieving the predefined purpose efficiently. The BMS 112, in an example, may use tools such as artificial intelligence based algorithms and data analytics to determine optimal scheduling instructions corresponding to each of the electrical sockets 106-1, 106-2, . . . , and 106-N.

In an embodiment, the BMS 112 may take into account variables that may affect the SOPs defined for the premises 102 to generate the scheduling instructions. In example implementations, the SOPs for the operation of the electrical sockets 106-1, 106-2, . . . , and 106-N may be defined in the BMS 112 by a manager of the premises 102. In an example, the variables affecting the SOPs may include, but are not limited to, temperature at the electrical sockets 106-1, 106-2, . . . , and 106-N, power consumption through these electrical sockets 106-1, 106-2, . . . , and 106-N, current draw, voltage fluctuations, and usage patterns of the assets 104-1, 104-2, . . . , and 104-N connected to these electrical sockets 106-1, 106-2, . . . , and 106-N. By considering such variables that may be determined based on the data from the sensors 108-1, 108-2, . . . , and 108-N, the BMS 112 may dynamically adjust the scheduling instructions for the operating parameters of the electrical sockets 106-1, 106-2, . . . , and 106-N so that predefined SOPs are observed. For example, if the temperature at a particular socket, such as the electrical socket 106-1, exceeds a predefined threshold, the BMS 112 may adjust the power output of the corresponding electrical socket 106-1 to prevent overheating, or if power consumption through the electrical socket 106-1 approaches its maximum rated capacity, the BMS 112 may redistribute the load to other electrical sockets or adjust the voltage or current limits of the electrical socket 106-1 to ensure safe operation. Additionally, based on usage patterns detected by the sensors 108-1, 108-2, . . . , and 108-N, the BMS 112 may dynamically adjust the on/off schedules of the electrical sockets to optimize energy consumption while maintaining the functionality of connected assets.

In an example, the adjustments in the scheduling instructions that are determined by the BMS 112 may be communicated via a network 114 to the central hub 110, which, in turn, operates actuators 116-1, 116-2, . . . , and 116-N, that may be connected to the central hub 110 either wirelessly or through wired connections, to control power distribution through the electrical sockets 106-1, 106-2, . . . , and 106-N. This control ensures that the operating parameters of the electrical sockets 106-1, 106-2, . . . , and 106-N are adjusted according to the scheduling instructions, reflecting the optimized settings and adhering to the predefined SOPs while maintaining energy efficiency. For example, if the BMS 112 determines that a particular area of the premises 102, for example, based on data from sensors installed in the premises 102 or based on data provided by the manager of the premises 102 based on occupancy pattern of the premises 102, is unoccupied during certain hours, the BMS 112 may instruct the central hub 110 to operate the actuator 116-1 to reduce or cut off power to the electrical socket 106-1 supplying a lighting fixture in that area. Similarly, if the BMS 112 detects through the data from the sensor 110-2 that the power consumption of a printer connected to electrical socket 106-2 is consistently high during non-business hours, the BMS 112 may instruct the central hub 110 to operate the actuator 116-2 to limit power supply to electrical socket 106-2 during those hours, thereby adjusting the operating parameters of the printer to align with energy efficiency goals.

In certain embodiments, such as in the case of smart electrical sockets, the actuators 116-1, 116-2, . . . , and 116-N may be inbuilt within the electrical sockets 106-1, 106-2, . . . , and 106-N themselves. In such cases, the central hub 110 may communicate directly with the smart electrical sockets to adjust their operating parameters based on the scheduling instructions from the BMS 112.

In an example, the network 114 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 114 includes various network entities, such as gateways, and routers; however, such details have been omitted for the sake of brevity of the present description.

In an example, the BMS 112 may be a server or other computing device (not illustrated) that communicatively couples to the central hub 110, for example, via the network 114. The server running the BMS 112 may be a standalone server or maybe a remote server on a cloud computing platform to which the central hub 110 may be connected over the network 114 directly or through the supervisory controller. In an embodiment, the server may be a cloud-based computing system. The server may include one or more servers on which an operating system may be installed that may run the BMS 112. The server may comprise one or more processing units, one or more storage devices, such as memory units, for storing data and machine-readable instructions for example, applications and application programming interfaces (APIs), and other peripherals required for providing cloud computing functionality.

In an implementation, depending on the configuration, i.e., on-premise or cloud-based, the operations of the electrical sockets 106-1, 106-2, . . . , and 106-N may be controlled by either the central hub 110 or the BMS 112. For example, in an on-premise configuration, the central hub 110 may have more direct control over the electrical sockets 106-1, 106-2, . . . , and 106-N, while in a cloud-based configuration, the BMS 112 may take a more prominent role in the control of the electrical sockets 106-1, 106-2, . . . , and 106-N, with the central hub 110 acting as an intermediary for executing commands.

In an embodiment, the premises 102 may be divided into a plurality of zones and there may be a separate central hub 110 for each zone of the premises 102. A zone within the premises 102 may refer to a specific area or section of the premises 102 where the SOPs are to be observed. For example, the zone may be a single room, a group of rooms, or an area within the building 102 that may have an electrical socket, such as the electrical socket 106-1, operable in accordance with the predefined SOPs for said zone. Each zone may have different occupancy patterns, thermal characteristics, or usage purposes, necessitating different SOPs. The BMS 112 may provide scheduling instructions to the central hub 110 of a zone corresponding to the SOP predefined for said zone for the operating parameters of the electrical assets of said zone based on which the central hub 110 may control the power distribution from the electrical socket.

To operate the electrical sockets 106-1, 106-2, . . . , and 106-N as per the predefined SOPs, the electrical sockets 106-1, 106-2, . . . , and 106-N may be grouped to enable coordinated control and management of power distribution. The grouping of the electrical sockets 106-1, 106-2, . . . , and 106-N may allow the central hub 110 to monitor and control multiple electrical sockets simultaneously, ensuring coordinated power distribution to achieve specific operational goals. For example, in an open office area, multiple electrical sockets supplying power to lighting fixtures may need to be controlled as a single unit to maintain consistent power distribution. Similarly, a group of electrical sockets in a particular department may need to be powered ‘on’ or ‘off’ together based on work schedules. By grouping the electrical sockets, the central hub 110 may implement SOPs that require coordinated control of multiple electrical sockets, such as synchronizing power distribution across different areas based on occupancy patterns, or managing power allocation across different zones of the premises 102 to balance electrical loads and optimize energy consumption. This grouping capability may enhance the ability of the central hub 110 to efficiently manage power distribution in the premises 102 and adhere to the predefined SOPs while providing flexibility for different operational scenarios.

In accordance with example embodiments of the present subject matter, to group the electrical sockets 106-1, 106-2, . . . , and 106-N, timestamp information from the electrical sockets 106-1, 106-2, . . . , and 106-N may be received at the BMS 112. The timestamp information may be one of operating parameters of the electrical sockets 106-1, 106-2, . . . , and 106-N that may be indicative of a time instance when each of the respective electrical sockets 106-1, 106-2, . . . , and 106-N comes online or is actuated. In the context of the BMS 112, when an electrical socket, such as the electrical socket 106-1, ‘comes online’ may refers to a detectable change of state of the electrical socket 106-1 from its previous condition. This change may involve the electrical socket 106-1 transitioning from a powered-off to a powered-on state, establishing a communication connection after being disconnected, registering itself on the network 114 after installation or reset, becoming responsive to commands after a period of non-responsiveness, or sending an initial status update upon activation. The BMS 112 and/or the central hub 110 may interpret this moment as the instance the BMS 112 and/or the central hub 110 recognizes the electrical socket 106-1 as an active, controllable entity, allowing the electrical socket 106-1 to record a timestamp information that may be used for grouping and management purposes.

In an example, the timestamp information may include, but are not limited to, the date and time of activation, a unique identifier for each electrical socket, power consumption at the time of activation, location or zone identifier of the electrical socket within the premises 102. In an example, the timestamp information may be sensed by the sensors 108-1, 108-2, . . . , 108-N of the respective electrical sockets 106-1, 106-2, . . . , and 106-N whenever the electrical sockets 106-1, 106-2, . . . , and 106-N are powered on, reset, or experience a change in their operational state. The timestamp information is transmitted to the central hub 110 and/or the BMS 112. In example implementations where the central hub 110 alone receives the timestamp information, the central hub 110 may in turn transmit the timestamp information to the BMS 112 for further processing. In an embodiment, in the case of smart electrical sockets, the timestamp information may be stored in the memory of the smart electrical sockets and transmitted to the central hub 110 continuously or at predetermined time intervals.

In an embodiment, the BMS 112 may analyze the timestamp information of the electrical sockets 106-1, 106-2, . . . , and 106-N to identify the electrical sockets 106-1, 106-2, . . . , and 106-N that are actuated within a predetermined time lapse of each other. In an example, the predetermined time lapse is provided to account for slight variations in activation times that may occur due to factors such as minor differences in electrical characteristics, physical distance from the power source, or processing delays caused by the central hub 110, for example. In doing so, the BMS 112 may sort the timestamp information of the electrical sockets 106-1, 106-2, . . . , and 106-N chronologically and then compare adjacent timestamps to determine if they fall within a configurable time tolerance, such as 1-2 minutes.

In an embodiment, based on the comparison of the timestamp information, the BMS 112 may then automatically group the electrical sockets 106-1, 106-2, . . . , and 106-N that are actuated within this time tolerance. Thus, it may be inferred that the electrical sockets 106-1, 106-2, . . . , and 106-N that are grouped together are connected to a common electrical circuit. For example, a printer may be connected to the electrical socket 106-1, a scanner associated with the printer may be connected to the electrical socket 106-2, and a nearby desk lamp may be connected to the electrical socket 106-3, all on the same electrical circuit. When this electrical circuit is energized, such as when a circuit breaker is switched on, these devices may come online nearly simultaneously. The BMS 112 may detect that the electrical sockets 106-1, 106-2, . . . , and 106-N have timestamp information within the predetermined time tolerance (e.g., all activated within 5 seconds of each other). Consequently, the BMS 112 may automatically group these electrical sockets 106-1, 106-2, . . . , and 106-N, recognizing that these electrical sockets 106-1, 106-2, . . . , and 106-N are connected to the same electrical circuit and potentially related in function, such as being part of the same workstation or office area.

In an embodiment, once the group is created, a configuration of the group may be recorded at the BMS 112. In an example, the configuration of the group may include an indication of each of the electrical sockets 106-1, 106-2, . . . , and 106-N identified to be in the group along with a zone corresponding to each of the identified electrical sockets 106-1, 106-2, . . . , and 106-N of the group. For example, a group named “Office Workstation A” may be configured in the BMS 112 as follows: Socket 106-1 (Computer, Zone: Location ID 1001), Socket 106-2 (Monitor, Zone: Location ID 1001), Socket 106-3 (Desk Lamp, Zone: Location ID 1001), Socket 106-4 (Printer, Zone: Location ID 1003), and Socket 106-5 (Phone Charger, Zone: Location ID 1001). This configuration allows the BMS 112 to maintain a comprehensive record of the electrical layout and usage within the specific office workstation, facilitating efficient power management and troubleshooting.

Thus, timestamp-based grouping of the electrical sockets may enable automatic and accurate identification of the electrical sockets connected to the same electrical circuit without requiring manual intervention. This also eliminates reliance on wiring diagrams that are not only complex to understand but are also often inaccurate. The system described herein simplifies the process of organizing and managing electrical infrastructure, especially in large or complex premises. This grouping facilitates more efficient power management, allowing for targeted energy conservation measures, load balancing, and fault detection at the circuit level. It also enhances safety by enabling quick identification of overloaded circuits or potential electrical issues. Furthermore, the timestamp-based grouping may provide valuable insights into usage patterns and help optimize the allocation of electrical resources across different zones or departments within a premises.

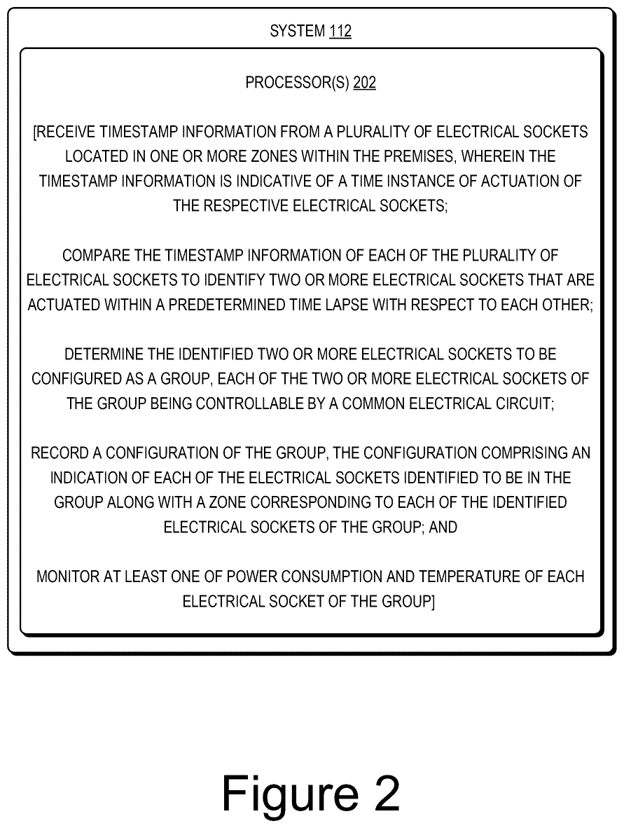

FIG. 2 illustrates the system 112 for grouping electrical sockets, such as the electrical sockets 106-1, 106-2, . . . , and 106-N, in accordance with an example implementation of the present subject matter. As explained previously, the system 112 may be a building management system (BMS). In an example, the BMS 112 be one or more computing devices, such as desktop computers, laptops, smartphones, personal digital assistants (PDAs), tablets and servers.

In an example, the BMS 112 may be a computing device comprising a processor 202. In an example, the processor 202 may be implemented as microprocessors, microcomputers, microcontrollers, digital signal processors, central processing units, state machines, logic circuitries, and/or any devices that manipulate signals based on operational instructions. The processor 202 may execute instructions stored in a memory of the BMS 112 to accomplish functionalities of the BMS 112.

As explained previously, the grouping of the electrical sockets 106-1, 106-2, . . . , and 106-N may be beneficial for efficient management of operations of premises, such as the premises 102 and energy optimization. By organizing the electrical sockets 106-1, 106-2, . . . , and 106-N into logical groups, managers of the premises 102 may gain better control and insight into power consumption patterns across different areas or functions within the premises 102. This grouping may allow for more targeted energy-saving strategies, such as scheduling power-off times for specific groups of the assets 104-1, 104-2, . . . , and 104-N or identifying areas of high energy usage. The grouping of the electrical sockets 106-1, 106-2, . . . , and 106-N may also facilitate easier troubleshooting and maintenance, as issues may be quickly isolated to specific groups or electrical circuits. The grouped electrical sockets 106-1, 106-2, . . . , and 106-N may enable more effective load balancing, reducing the risk of circuit overloads and enhancing overall electrical system reliability. Additionally, grouping of the electrical sockets 106-1, 106-2, . . . , and 106-N also supports more granular monitoring and reporting, providing valuable data for energy audits, cost allocation, and sustainability initiatives. In smart building applications, grouped electrical sockets 106-1, 106-2, . . . , and 106-N may be integrated with other systems like occupancy sensors or HVAC controls for more comprehensive and efficient building automation. Overall, the strategic grouping of the electrical sockets 106-1, 106-2, . . . , and 106-N contributes to improved energy management, cost reduction, and enhanced operational efficiency in modern buildings.

According to an example implementation, the BMS 112 provides for the grouping of the electrical sockets 106-1, 106-2, . . . , and 106-N within the premises 102 such that each group of the electrical sockets 106-1, 106-2, . . . , and 106-N may be operated in accordance with a standard operating procedure (SOP) defined for said group of the electrical sockets 106-1, 106-2, . . . , and 106-N.

As described with reference to FIG. 1, timestamp information in respect to the electrical sockets 106-1, 106-2, . . . , and 106-N located in one or more zones within the premises 102 may be required to group the electrical sockets.

In an example, the timestamp information of the electrical sockets 106-1, 106-2, . . . , and 106-N may be sensed by the sensors 108-1, 108-2, . . . , 108-N connected to the respective electrical sockets 106-1, 106-2, . . . , and 106-N whenever the electrical sockets 106-1, 106-2, . . . , and 106-N are actuated. As explained previously, the electrical sockets 106-1, 106-2, . . . , and 106-N may be smart electrical sockets with built-in sensors for sensing the timestamp information and memory component for storing the same. In an example, the timestamp information sensed by the sensors 108-1, 108-2, . . . , 108-N may be transmitted to the central hub 110. The central hub 110 may then transmit the timestamp information to the BMS 112 for further processing. In an embodiment, in cases where the central hub 110 alone receives the timestamp information, the central hub 110 may in turn transmit the timestamp information directly to the BMS 112 for further processing.

In an embodiment, the BMS 112 may analyze the timestamp information of the electrical sockets 106-1, 106-2, . . . , and 106-N to identify all the electrical sockets 106-1, 106-2, . . . , and 106-N that are actuated within a predetermined time interval of each other. This predetermined time interval accounts for minor differences in activation times that may arise from various factors. These factors may include, but are not limited to, slight variations in electrical properties of individual electrical sockets 106-1, 106-2, . . . , and 106-N, differences in the physical proximity of the electrical sockets 106-1, 106-2, . . . , and 106-N to the power source, or latency in data processing and transmission within the central hub 110. By allowing for this tolerance, the BMS 112 may accurately group the electrical sockets from amongst the plurality of electrical sockets 106-1, 106-2, . . . , and 106-N that are part of the same circuit despite small timing differences in their activation. The BMS 112 may sort the timestamp information chronologically and then compare adjacent timestamps to determine if they fall within a configurable time tolerance.

Based on this timestamp information comparison, the BMS 112 may automatically determine two or more electrical sockets, from amongst the plurality of electrical socket 106-1, 106-2, . . . , and 106-N that come online within the predetermined time interval, to be in the same group. The analysis of the timestamp information may thus determine the electrical sockets that are connected to the same electrical circuit. By identifying electrical sockets with timestamp information falling within the predetermined time interval, the BMS 112 may create logical groupings. These groupings may indicate not only a common circuit connection among the grouped electrical sockets, but also possible functional relationships between the grouped electrical sockets.

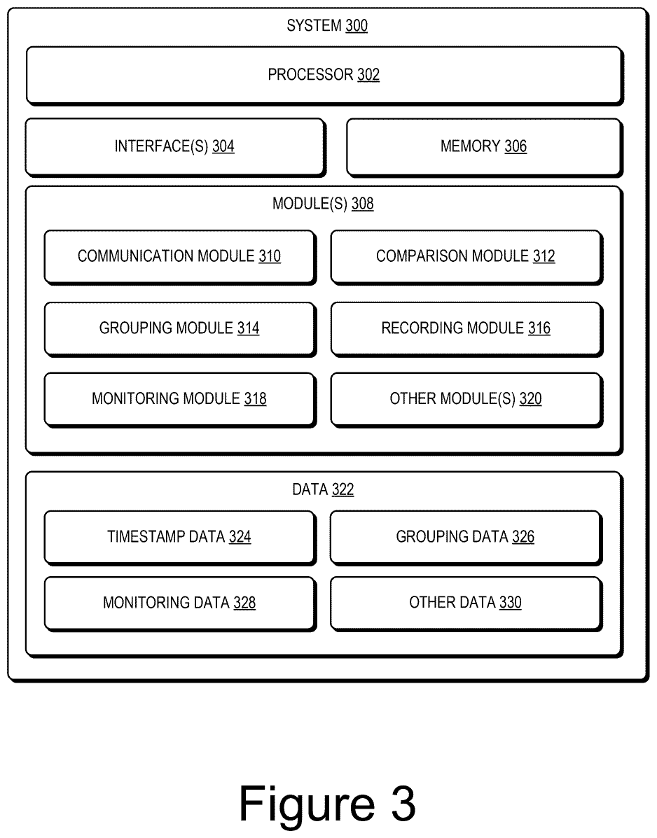

In an example, once a group is created, configuration of the group may be recorded in the BMS 112. This configuration may include an indication of each electrical socket in the group along with its corresponding zone. This detailed configuration allows the BMS 112 to maintain a comprehensive record of the electrical layout and usage within specific areas, facilitating efficient power management and troubleshooting. Once the electrical sockets 106-1, 106-2, . . . , and 106-N are grouped, each group may be managed and operated according to a predefined SOP specific to that group. This allows for tailored control and management of different sets of the electrical sockets 106-1, 106-2, . . . , and 106-N based on their grouping and associated functions. For example, a group of electrical sockets powering office equipment in a particular area of the office building may have an SOP that includes automatically shutting off power to these sockets outside of business hours to prevent standby power consumption. Another group of electrical sockets associated with critical systems may have an SOP that ensures continuous power supply and triggers immediate alerts if any interruption is detected. In a laboratory setting, a group of electrical sockets powering sensitive equipment may have an SOP that includes voltage regulation and power quality monitoring. These tailored SOPs may enable the BMS 112 to optimize energy usage, enhance equipment longevity, and maintain appropriate power conditions for different areas and functions within the premises 102. To elaborate on the functionality of the system 112 for grouping of the electrical sockets 106-1, 106-2, . . . , and 106-N, reference is made to FIG. 3.

FIG. 3 illustrates a system 300 for grouping of electrical circuits, such as the electrical circuits 108-1, 108-2, . . . , and 108-N, according to an example implementation of the present subject matter. In an embodiment, the system 300 may be similar to the system 112 explained in reference to FIGS. 1-2. In an example, the system 300 may be any computing device, such as servers, desktop computers, laptops, smartphones, personal digital assistants (PDAs), and tablets.

In an example, the system 300 comprises a processor 302, such as the above-described processor 202. In an example, the processor 302 may be implemented as microprocessors, microcomputers, microcontrollers, digital signal processors, central processing units, state machines, logic circuitries, and/or any devices that manipulate signals based on operational instructions. The system 300 also comprise interface(s) 304 coupled to the processor 302. The interface(s) 304 may include a variety of software and hardware interfaces that allow interaction of the system 300 with other communication and computing devices, such as network entities, web servers, and external repositories, and peripheral devices. For example, the interface(s) 304 may couple the system 300 with the central hub 110. The interface(s) 304 may also enable coupling of internal components of the system 300 with each other.

Further, the system 300 comprises a memory 306 coupled to the processor 302. The memory 306 may include any computer-readable medium known in the art including, for example, volatile memory (e.g., RAM), and/or non-volatile memory (e.g., EPROM, flash memory, etc.). The memory 306 may also be an external memory unit, such as a flash drive, a compact disk drive, an external hard disk drive, or the like. The system 300 may comprise module(s) 308 and data 322 coupled to the processor 302. In one example, the module(s) 308 and data 322 may reside in the memory 306.

In an example, the data 316 may comprise timestamp data 324, grouping data 326, monitoring data 328, and other data 330. The module(s) 308 may include routines, programs, objects, components, data structures, and the like, which perform particular tasks or implement particular abstract data types. The module(s) 308 further includes modules that supplement applications on the system 300, for example, modules of an operating system. The data 322 serves, amongst other things, as a repository for storing data that may be fetched, processed, received, or generated by one or more of the module(s) 308. The module(s) 308 may include a communication module 310, a comparison module 312, a grouping module 314, recording module 316, monitoring module 318, and other module(s) 320. The other module(s) 320 may include programs or coded instructions that supplement applications and functions, for example, programs in the operating system of the system 300.

As explained previously, in a given premises, such as the premises 102, each of the electrical sockets 106-1, 106-2, . . . , and 106-N may be operated so as to regulate its operating parameters in accordance with predefined SOPs. The operating parameters of an electrical socket, such as the electrical socket 106-1, may be understood as operational state of the electrical socket 106-1, such as ‘on’ or ‘off’ state and other variable parameters comprising electrical parameters that may be controlled or measured during operation of the electrical socket 106-1, such as power consumption, voltage, current, and frequency. These operating parameters may vary depending on the specific type and function of the electrical socket 106-1. For example, a smart electrical socket may have parameters related to power consumption and operational schedule, while a standard electrical socket may only have basic on/off functionality. Monitoring and controlling these operating parameters allows for optimal performance, energy efficiency, and maintenance of the electrical sockets within the premises 102.

The central hub 110 may control the operating parameters of the electrical sockets 106-1, 106-2, . . . , and 106-N in accordance with predefined SOPs specific to each electrical socket. Concurrently, the sensors 108-1, 108-2, . . . , and 108-N, which are respectively coupled to the electrical sockets 106-1, 106-2, . . . , and 106-N, may measure these operating parameters. This arrangement allows for both active management and real-time monitoring of the performance of the electrical sockets 106-1, 106-2, . . . , and 106-N and conditions within the premises 102. This monitoring and control allows the central hub 110 to oversee the proper functioning of the electrical sockets 106-1, 106-2, . . . , and 106-N according to the predefined SOPs, optimizing operations within the premises 102.

In an example, to monitor the operation of the electrical sockets 106-1, 106-2, . . . , and 106-N, the central hub 110 may receive current values of the operating parameters of the electrical sockets 106-1, 106-2, . . . , and 106-N from corresponding the sensors 108-1, 108-2, . . . , and 108-N, or directly from the electrical sockets 106-1, 106-2, . . . , and 106-N themselves. The central hub 110 may then compare these current values with the predefined SOPs provided by the system 300. If necessary, the central hub 110 may modify the operating parameters of the electrical sockets 106-1, 106-2, . . . , and 106-N to ensure their operation aligns with the predefined SOPs. These SOPs typically define an acceptable range of values for each operating parameter of the electrical sockets 106-1, 106-2, . . . , and 106-N, providing guidelines for optimal performance and maintenance.

In some cases, two or more electrical sockets of the electrical sockets 106-1, 106-2, . . . , and 106-N that are on a same electrical circuit may be grouped together to be operated in accordance with a predefined SOP for the group. This grouping may be based on various factors such as functional relationships, spatial proximity, or interdependencies between the electrical sockets. For example, multiple electrical sockets connected to the same electrical circuit may be grouped together. This grouping may include electrical sockets powering various devices such as computers, printers, and other office equipment in a particular area. Similarly, a set of electrical sockets in a specific zone, such as a conference room or a section of an office space, may form a group. The predefined SOP for such an electrical socket group may encompass coordinated power management schedules, synchronized on/off timings, or collective energy consumption targets. This electrical socket-based grouping approach may enhance overall energy efficiency, simplify power management, and ensure cohesive operation of related electrical loads. The central hub 110 may manage these electrical socket groups as single entities, applying group-specific SOPs while still maintaining the ability to control and monitor individual electrical sockets within the group when applicable. This allows for both macro-level optimization of electrical socket groups and micro-level control of individual electrical sockets, enabling precise power management and energy conservation strategies.

As explained previously with reference to FIG. 1, the system 300 manages grouping of the electrical sockets 106-1, 106-2, . . . , and 106-N installed in the premises 102. As explained previously, the grouping of the electrical sockets 106-1, 106-2, . . . , and 106-N may involve analysing timestamp information indicating when each electrical socket is actuated, for instance, to identify the electrical sockets from amongst the 108-1, 108-2, . . . , and 108-N that were activated within a predetermined time interval of each other.

In an example embodiment of the present subject matter, the communication module 310 may receive timestamp information corresponding to the actuation of the electrical sockets 106-1, 106-2, . . . , and 106-N installed in the premises 102. The premises 102 may be wired with multiple electrical circuits that cover one or more zones, i.e., physical locations such as rooms, floors, or specific areas within the premises 102. These electrical circuits form the infrastructure through which the electrical sockets 106-1, 106-2, . . . , and 106-N are powered and connected. The timestamp information received by the communication module 310 may thus reflect the activation patterns of the electrical sockets 106-1, 106-2, . . . , and 106-N across various zones and electrical circuits within the premises 102.

In an example, each of the plurality of electrical sockets 106-1, 106-2, . . . , and 106-N may be communicatively coupled to the system 300, for example, through the central hub 110 or gateway, transmitting timestamp information indicating when each electrical socket comes online or is actuated.

In an example, the timestamp information corresponding to each of the electrical sockets 106-1, 106-2, . . . , and 106-N may be sensed by the corresponding sensors 108-1, 108-2, . . . , and 108-N. These sensors 108-1, 108-2, . . . , and 108-N may be integrated within the electrical sockets 106-1, 106-2, . . . , and 106-N or installed nearby and communicatively couple to the electrical sockets 106-1, 106-2, . . . , and 106-N. The sensors 108-1, 108-2, . . . , and 108-N transmit this data to the central hub 110, which may act as an intermediary data aggregator. The central hub 110 may then process and transmit the aggregated timestamp information to the system 300. In an alternative embodiment, the data sensed by the sensors 108-1, 108-2, . . . , and 108-N may be transmitted directly to the system 300, for example, over the network 114. In an example, the transmission may occur in real-time or at predetermined intervals, depending on the configuration of the system 300 and requirements. The timestamp information may include not only the exact time of actuation but also additional metadata such as the unique identifier of the electrical sockets 106-1, 106-2, . . . , and 106-N, physical location of the electrical sockets 106-1, 106-2, . . . , and 106-N within the premises 102, and the specific electrical circuit the electrical sockets 106-1, 106-2, . . . , and 106-N the belongs to. In an example, the timestamp information corresponds to the actuation of the electrical sockets 106-1, 106-2, . . . , and 106-N received by the system 300 may be stored in the memory 306 of the system 300 as the timestamp data 324.

In an embodiment, based on the timestamp data 324, the comparison module 312 may process and interpret the activation times of different electrical sockets 106-1, 106-2, . . . , and 106-N within the premises 102 to identify patterns or correlations in the activation times that may indicate which sockets are likely connected to the same electrical circuit. In its operation, the comparison module 312 may examine the timestamp information for each electrical socket, which includes the instance of time when a socket came online or is actuated. The comparison module 312 may then compares these timestamps information across all the electrical sockets 106-1, 106-2, . . . , and 106-N in the premises 102. In an example, the comparison module 312 looks for instances where multiple electrical sockets 106-1, 106-2, . . . , and 106-N are activated within a very short time frame of each other. This near-simultaneous activation may be considered an indicator that these electrical sockets may be on the same electrical circuit.

In an example, to account for slight variations in activation times that may occur even on the same electrical circuit, the comparison module 312 may employ a configurable time tolerance that may be set, for example, by the manager of the premises 102. This tolerance may allow the comparison module 312 to consider the electrical sockets 106-1, 106-2, . . . , and 106-N as potentially belonging to the same electrical circuit even if their activation times are not exactly simultaneous, but fall within a specified range, such as within 1-2 seconds of each other. The time tolerance may be adjusted, for example, based on user inputs, depending on the specific characteristics of the electrical system in the premises 102 and the desired accuracy of the grouping process.

In an embodiment, based on the comparison of the timestamp information of each of the electrical sockets 106-1, 106-2, . . . , and 106-N, the grouping module 314 may form one or more groups of the electrical sockets 106-1, 106-2, . . . , and 106-N. In an example, these groups may be created to reflect the actual electrical circuits to which the electrical sockets 106-1, 106-2, . . . , and 106-N belong. The grouping module 314 utilizes the analysis performed by the comparison module 312 to identify electrical sockets from amongst the electrical sockets 106-1, 106-2, . . . , and 106-N that consistently activate simultaneously or within a predefined time tolerance, indicating their connection to the same electrical circuit. This grouping process maps the underlying electrical circuit structure of the premises 102, organizing the electrical sockets 106-1, 106-2, . . . , and 106-N according to their physical wiring connections. For example, if the electrical sockets 108-1, 108-3, and 108-5 consistently come online within milliseconds of each other when power is restored after an outage, the grouping module 314 may identify these electrical sockets 108-1, 108-3, and 108-5 as belonging to the same electrical circuit and group them together. Similarly, if the electrical sockets 108-2, 108-4, and 108-6 show a consistent pattern of simultaneous activation, they may be grouped as another distinct circuit. This grouping allows for more efficient power management, as the system 300 may now understand which electrical sockets are interconnected and may be controlled or monitored as a unit. Furthermore, this circuit-based grouping may aid in load balancing, fault detection, and targeted energy conservation measures within specific zones of the premises 102.

In an embodiment, the recording module 316 may capture the information regarding the grouping of the electrical sockets 108-2, 108-4, and 108-6 and the same may be stored in the memory 306 of the system 300 as grouping data 326. In an example, the recording module 316 may also record the configuration of the grouped electrical sockets 106-1, 106-2, . . . , and 106-N, as determined by the grouping module 314, in the grouping data 326 within the memory 306 of the system 300. In example implementations, the configuration information may be stored as additional data, complementing the existing grouping information.

In an example, the recorded configuration may include a group identifier for each group of electrical sockets, the zone associated with each group, and the individual socket identifiers within that group. For example, a configuration entry may contain Group ID: G001, Zone: Conference Room A, Socket IDs: 108-1, 108-3, 108-5. This allows the system 300 to organize and access information about the electrical layout of the premises 102, facilitating targeted power management, troubleshooting, and energy optimization strategies based on both circuit groupings and physical locations. For example, if the system 300 detects an unusually high power draw from the group G001 in the Conference Room A, the system 300 may identify that electrical sockets 108-1, 108-3, and 108-5 are involved. The manager of the premises 102 may then investigate these specific electrical sockets 108-1, 108-3, and 108-5 for issues, such as malfunctioning equipment or unauthorized high-power devices. Additionally, if the premises 102 implements a power-saving policy for conference rooms during off-hours, the system 300 may target the electrical sockets in the “Conference Room A” zone for automated power reduction, improving energy efficiency. In case of a circuit overload, the system 300 may identify the devices that are connected to the affected electrical sockets and take appropriate action, such as sending alerts to building operations management personnel, or automatically powering down non-essential devices in that group to prevent potential issues, such as power outage of safety hazard.

In an embodiment, the monitoring module 318 may continuously or intermittently monitor the temperature of each electrical socket 106-1, 108-2, . . . , and 108-N within the groups. By tracking temperature data, the monitoring module 318 detects issues such as overloading, faulty wiring, or malfunctioning devices before they escalate into more serious problems. In operation, the monitoring module 318 may receive temperature data from the sensors 108-1, 108-2, . . . , and 108-N integrated into or associated with each electrical socket 106-1, 108-2, . . . , and 108-N of the groups. The monitoring module 318 may compare these temperature readings against a predetermined threshold value, which is set based on safety standards and the specific characteristics of the electrical system and the premises 102. If the temperature at any of the electrical sockets 106-1, 106-2, . . . , and 106-N exceeds this threshold, the monitoring module 318 may generate an alarm, for example, in the form of visual alerts, audible alarms, or automated notifications to manager of the premises. For example, considering a group of electrical sockets in a server room, labelled as 108-7, 108-8, and 108-9, the monitoring module 318 may receive temperature data from these electrical sockets. If the temperature at socket 106-8 suddenly rises to 65° C., exceeding the predetermined threshold of 60° C., the monitoring module 318 may trigger an alarm. This alarm may alert an IT staff that there is a potential issue with the equipment plugged into the electrical socket 106-8, allowing them to investigate and address the problem, preventing a server overheating incident or averting a potential fire hazard.

Similarly, in an embodiment, the monitoring module 318 may monitor the power consumption of each electrical socket 106-1, 108-2, . . . , and 108-N within the groups. Tracking power consumption data enables the monitoring module 318 to detect issues, such as overloading, energy inefficiencies, or unauthorized high-power devices in real-time to initiate corrective actions to mitigate further problems. The monitoring module 318 may receive power consumption data from the sensors 108-1, 108-2, . . . , and 108-N integrated into or associated with each electrical socket 106-1, 108-2, . . . , and 108-N of the groups. The monitoring module 318 may compare these power consumption readings against a predetermined threshold value, which is predefined based on the electrical capacity of the electrical circuit and the specific energy management policies of the premises 102. If the power consumption at any of the electrical sockets 106-1, 106-2, . . . , and 106-N exceeds this threshold, the monitoring module 318 may generate an alarm, for example, in the form of visual alerts, audible alarms, or automated notifications to the manager of the premises 102. For example, considering a group of electrical sockets in an office area, labelled as 108-10, 108-11, and 108-12, the monitoring module 318 may receive power consumption data from these electrical sockets 108-10, 108-11, and 108-12. If the power consumption at the socket 106-11 suddenly rises to 1500 W, exceeding the predetermined threshold of 1200 W, the monitoring module 318 may trigger an alarm. This alarm may alert the manager of the office that there is an issue with the equipment plugged into the electrical socket 106-11, allowing them to investigate and address the problem promptly, preventing circuit overload or identifying unauthorized high-power devices.

Therefore, the present subject matter provides a solution for automatic grouping and monitoring of electrical sockets that adapt to various types of electrical issues, including power consumption and temperature anomalies. The present subject matter provides for the generation of appropriate groupings and monitoring thresholds to address these identified issues within the electrical system with minimal human intervention. This enables efficient and timely responses to potential electrical hazards and energy inefficiencies in building management systems. Furthermore, the present subject matter integrates multiple workflows, such as socket grouping, power consumption monitoring, temperature monitoring, and automated alarm generation, into a unified process. This integration streamlines the entire electrical system management and improvement lifecycle, allowing for seamless handling of different types of electrical monitoring and control within a single framework. As a result, the present subject matter enhances overall electrical safety, mitigates overload risks, improves energy efficiency, and optimizes the entire electrical management process of the premises.

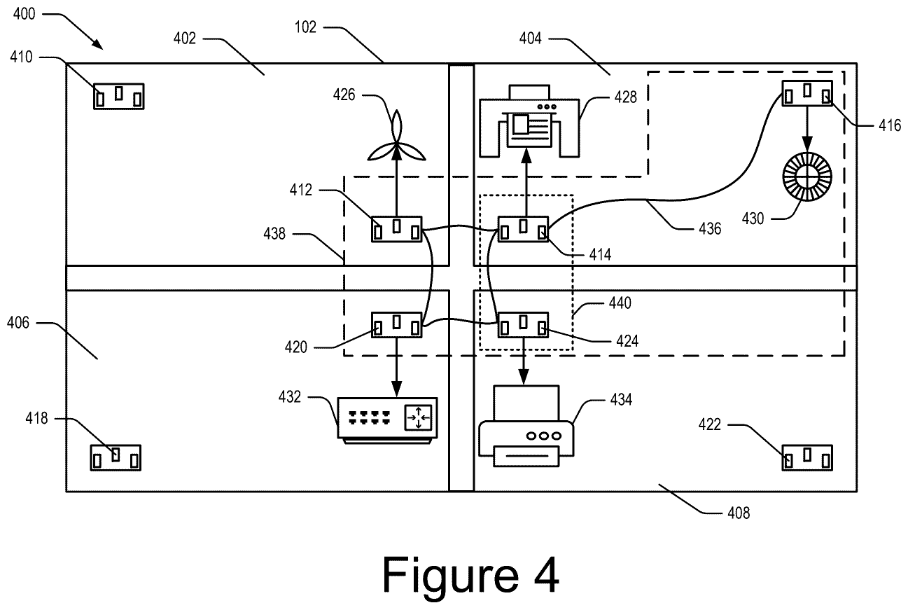

FIG. 4 illustrates an exemplary representation 400 for sub-grouping of electrical sockets, such as the electrical sockets 106-1, 106-2, . . . , and 106-N, according to an example implementation of the present subject matter.

According to an example embodiment of the present subject matter, each of the plurality of groups of the electrical sockets 106-1, 106-2, . . . , and 106-N may be further divided into one or more sub-groups. In an example, sub-grouping of the electrical sockets 106-1, 106-2, . . . , and 106-N within a group may enhance the flexibility, efficiency, and precision in the management of the electrical infrastructure of the premises 102. The sub-grouping of the electrical sockets 106-1, 106-2, . . . , and 106-N may allow for more granular control and monitoring of power distribution, enabling functional zoning, load balancing, and targeted energy management strategies. The sub-grouping of the electrical sockets 106-1, 106-2, . . . , and 106-N facilitates easier maintenance and troubleshooting, supports customized monitoring for different areas, and provides scalability to adapt to changing usage-based needs. It also allows for more effective occupancy-based control, aids in regulatory compliance for specific areas, and enables more meaningful data analysis for system optimization. Additionally, sub-grouping can improve emergency management capabilities by allowing rapid, targeted responses to electrical issues.

According to an example embodiment of the present subject matter, to create the sub-grouping of the electrical sockets 106-1, 106-2, . . . , and 106-N within a group, the system 300 may be configured to utilize various criteria such as spatial proximity, functional relationships, or specific power requirements. In some embodiments, the system 300 may employ machine learning algorithms to analyze usage patterns and automatically suggest optimal sub-groupings. These algorithms may consider factors such as time-of-day usage, power consumption profiles, and correlations between electrical socket activations. In some embodiments, the system 300 may also incorporate user-defined rules for sub-grouping. For example, the manager of the premises 102 may specify that all electrical sockets within a group powering critical equipment should be grouped together for priority power management. Additionally, in some embodiments, the system 300 may use data from occupancy sensors to dynamically adjust sub-groups based on real-time space utilization.

In some implementations, the system 300 may consider the physical layout of the premises 102, using data from building information modelling (BIM) systems to create logical sub-groups based on room boundaries, floor levels, or building wings. The system 300 may also factor in the electrical capacity of different electrical circuits, ensuring that sub-groups do not exceed safe power limits. In some example embodiments, the sub-grouping process may be adaptive, with the system 300 periodically reassessing and adjusting groups based on changing usage patterns or the addition of new assets. This may ensure that the sub-grouping remains optimal over time, even as the needs of the premises evolve.

In operation, as illustrated in FIG. 4, the premises 102 may be segmented into multiple zones, such as a first zone 402, a second zone 404, a third zone 406, and a fourth zone 408. Within each of these zones - the first zone 402, second zone 404, third zone 406, and fourth zone 408-there may be various electrical sockets and their associated assets. The electrical sockets may be identified as a first electrical socket 410, second electrical socket 412, third electrical socket 414, fourth electrical socket 416, fifth electrical socket 418, sixth electrical socket 420, seventh electrical socket 422, and eighth electrical socket 424. Connected to these electrical sockets may be assets, such as a fan 426, a plotter 428, a table lamp 430, a Wi-Fi router 432, and a printer 434. In that, the fan 426 may be connected to the second electrical socket 412 located in the first zone 402, the plotter 428 may be connected to the third electrical socket 414 of the second zone 404, the table lamp 430 may be connected to the fourth electrical socket 416 of the second zone 404, the Wi-Fi router 432 may be connected to the sixth electrical socket 420 of the third zone 406, and the printer 434 may be connected to the eighth electrical socket 424 of the fourth zone 408.

In an example, based on monitoring of time instances of actuation of each of the first to eighth electrical sockets 410-424 installed in the premises 102 over a predetermined duration, the system 300 may identify the second electrical socket 412, third electrical socket 414, fourth electrical socket 416, sixth electrical socket 420, and eighth electrical socket 425 as a group 438 connected to a common electrical circuit 436.

In another example, the system 300 may identify that the plotter 428 and the printer 434 are related assets as they are both printing devices and may be used for similar purposes within the premises 102, or may be typically operated during similar time periods. Based on this identification, the system 300 may create a sub-group 440 within the group 438 that includes the third electrical socket 414 connected to the plotter 428 and the eighth electrical socket 424 connected to the printer 434. This may enable more specific monitoring and management of printing-related power consumption within the premises 102.

In one embodiment, the sub-group 440 creation may be based on input from the manager of the premises 102. The manager may manually designate the plotter 428 and the printer 434 as related assets through a user interface of the system 300, prompting the system 400 to create the sub-group 440 within group 438. In another embodiment, the system 300 may create the sub-group 440 based on its own analysis of the group 438 using the machine learning algorithms. The machine learning algorithms may analyze power consumption patterns, usage times, and device types to automatically identify the relationship between the plotter 428 and the printer 434, leading to the creation of the sub-group 440 without manual input from the manager of the premises 102.

Thus, sub-grouping of electrical sockets, such as the electrical sockets 106-1, 106-2, . . . , and 106-N irrespective of the zone of operation of the electrical sockets 106-1, 106-2, . . . , and 106-N may allow for more precise control and monitoring of power consumption through the electrical sockets 106-1, 106-2, . . . , and 106-N. For example, referring to the previous example, the system 300 may monitor the power consumption of the sub-group 440 containing the third electrical socket 414 and the eighth electrical socket 424, which are connected to the plotter 428 and the printer 434 respectively. This monitoring may enable the system 300 to identify unusual power consumption patterns or potential issues specific to the printing devices.

In another aspect, the system 300 may also monitor the temperature of the sub-group 440. For example, the system 300 may use temperature sensors associated with the third electrical socket 414 and the eighth electrical socket 424 to detect any abnormal heat generation. If the temperature of either electrical socket exceeds a predetermined threshold, the system 300 may indicate an overload or malfunction in the connected printing device. The system 300 may then generate an alarm to notify the manager of the premises 102 of the potential issue, allowing for prompt investigation and preventive maintenance.

Accordingly, the system 300 may maintain overall control of the entire electrical infrastructure of the premises 102 while also allowing for granular management at individual electrical socket levels, thereby optimizing energy usage and enhancing operational efficiency across the premises 102.

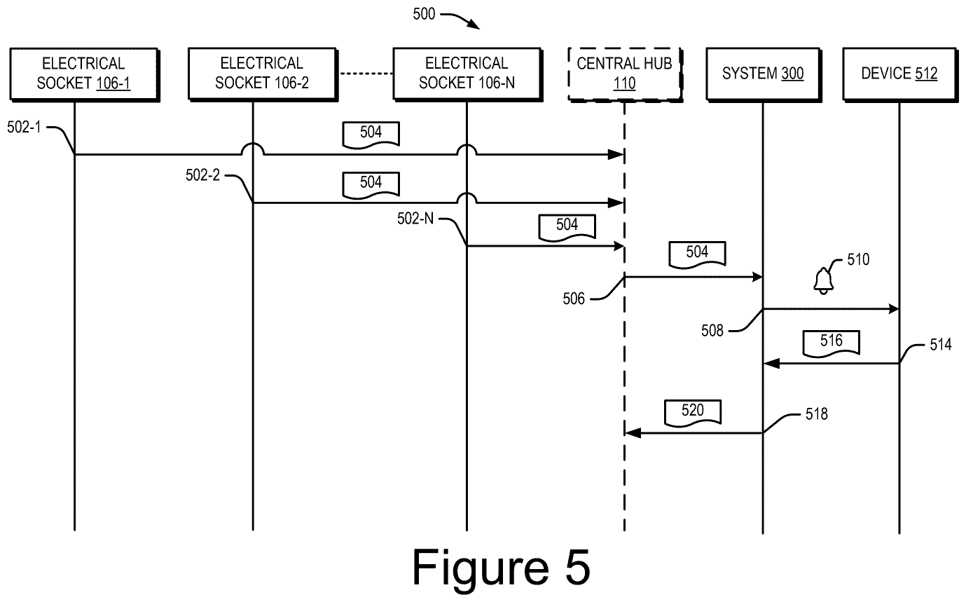

FIG. 5 illustrates a signal flow diagram 500 depicting signal flow in a process of grouping of electrical sockets, such as the electrical sockets 106-1, 106-2, . . . , and 106-N, in accordance with an example implementation of the present subject matter.

As explained previously with reference to FIGS. 1-3, the grouping of the electrical sockets 106-1, 106-2, . . . , and 106-N may be carried out to facilitate the implementation and execution of the SOPs predefined for premises, such as the premises 102. By organizing the electrical sockets 106-1, 106-2, . . . , and 106-N into logical groups, such as the group 438, based on their electrical circuit connections, the system 300 may more effectively apply and manage the predefined SOPs across the electrical infrastructure of the premises 102. For example, the grouping of the electrical sockets 106-1, 106-2, . . . , and 106-N may allow for the creation of circuit-specific SOPs that may be uniformly applied to all electrical sockets within that group 438. Similarly, SOPs for maintenance or troubleshooting may be streamlined for technicians associated with the premises 102 to identify and work with specific groups of electrical sockets that are likely to be affected by the same issues. Grouping may also enhance the ability to create and enforce safety-related SOPs.

According to an example implementation of the present subject matter, as indicated in steps 502-1, 502-2, . . . , 502-N, to be able to assign the electrical sockets 106-1, 106-2, . . . , and 106-N to a group, data 504 pertaining to timestamp information corresponding to each electrical socket 106-1, 106-2, . . . , and 106-N, respectively, may be received at the central hub 110. In an example, the sensors 108-1, 108-2, . . . , and 108-N integrated into or associated with each electrical socket 106-1, 106-2, . . . , and 106-N may be used to sense the timestamp information corresponding to each electrical socket 106-1, 106-2, . . . , and 106-N. In an example, the timestamp information may be indicative of when each electrical socket came online or is powered on. In an embodiment, in the case of the smart electrical sockets, the timestamp information may be stored in the memory of the smart electrical sockets and communicated to the central hub 110.

In an embodiment, as indicated in step 506, when the central hub 110 receives the timestamp information corresponding to the plurality of electrical sockets 106-1, 106-2, . . . , and 106-N, the central hub 110 may, in turn, transmit the timestamp information to the system 300 for further processing. In an embodiment, the central hub 110 may be optional, and the timestamp information may be transmitted directly to the system 300 by the electrical sockets 106-1, 106-2, . . . , and 106-N. In such cases, the electrical sockets 106-1, 106-2, . . . , and 106-N may be smart electrical sockets equipped with network connectivity capabilities to communicate directly with the system 300, for example, over the network 114, enabling real-time data transmission and processing without the need for an intermediary central hub. These smart electrical sockets may incorporate Internet of Things (IoT) capabilities, including built-in Wi-Fi, Bluetooth, or other wireless communication protocols. Such IoT-enabled electrical sockets may autonomously connect to the network 114, transmit data, and receive commands, facilitating seamless integration with the system 300.

In an embodiment, the system 300 may analyze the timestamp information of each of the electrical sockets 106-1, 106-2, . . . , and 106-N received over a period of time to identify the electrical sockets 106-1, 106-2, . . . , and 106-N that are actuated within a predetermined time lapse of each other. In an example, the predetermined time lapse may be implemented to accommodate minor variations in actuation times of the electrical sockets 106-1, 106-2, . . . , and 106-N. These variations may arise from several factors, including slight differences in electrical characteristics of the electrical sockets 106-1, 106-2, . . . , and 106-N, varying physical distances from the power source, or processing delays introduced by the central hub 110. In doing so, the system 300 may sort the timestamp information of the electrical sockets 106-1, 106-2, . . . , and 106-N chronologically and then compare adjacent timestamps to determine if they fall within a configurable time lapse, such as a few seconds.

Based on this comparison, the system 300 may identify two or more of the electrical sockets 106-1, 106-2, . . . , and 106-N, as belonging to the same electrical circuit and configure them as a group, such as the group 438, in the memory 306 of the system 300. In an example, this grouping process may involve creating a data structure in the memory 306 that associates the identified electrical sockets of the group 438 with a unique group identifier. In an example, the system 300 may also assign metadata to the group 438, such as the estimated total capacity of the electrical socket of the group 438, the location of each electrical socket of the group within the premises 102, or any specific usage patterns observed. Additionally, the system 300 may implement a hierarchical grouping structure, allowing for the creation of sub-groups, such as the sub-group 440, within the group 438 to accommodate complex electrical layouts. In an example, once grouped, the operation of the electrical sockets of the group 438 may be collectively monitored, controlled, and analyzed as a single unit.

In an example, to monitor the operation of the electrical sockets, such as the electrical socket 424 of the group 438, the system 300 may receive the data indicative of the current operating parameters of the electrical socket 424 as sensed by a sensor, such as the sensor 108-1, coupled to the electrical socket 424. In an example, the system 300 may analyze the operating parameters of the electrical socket 424 to determine if the value of an operating parameter from the plurality of operating parameters exceeds a predefined threshold. As indicated in step 508, upon determining that the value of the operating parameter exceeds the predefined threshold, the system 300 may generate an alarm or notify the manager of the premises 102, for example, by sending a notification 510 on a device 512 associated with the manager of the premises 102. The device 512, for example, may be a device located in a control room of the premises 102, wherein BMS, hub, and other devices relating to building operations management may be installed. For example, the system 300 may monitor the temperature of the electrical socket 424 of the entire group 438. If the temperature of the electrical socket 424 or the average temperature of the group 438 exceeds a predefined threshold, such as 60° C., the system 300 may generate an alarm or send the notification 510 on the device 512.

In an embodiment, the notification 510 may also include one or more recommendations to bring the operating parameters of the electrical socket 424 within the permissible range in accordance with the predefined SOP. For example, if the temperature at the electrical socket 424 exceeds the predefined threshold, the notification may suggest reducing the load on that electrical socket, redistributing the load across other electrical sockets in the group 438, or scheduling an inspection of the electrical socket 424. These recommendations may help the user associated with the device 512 to take prompt and appropriate action to address the issue and ensure the safe and efficient operation of the electrical system of the premises 102.

In an example, as indicated in step 514, the manager of the premises 102 may give an instruction 516 to the system 300 by sending a signal either through the device 512 or by accessing the system 300 directly to either implement one of the recommendations suggested by the system 300 or may input their own corrective action into the system 300. For instance, the manager may provide an instruction to switch off the electrical socket 424 that is exhibiting abnormal behavior. Additionally, the manager may choose to reduce the load on an electrical circuit, such as the electrical circuit 436, of the group 438, by instructing the system 300 to power down non-essential assets connected to other electrical sockets in the same group 438. In cases where the issue is recurring, the manager may use the system 300 to implement a long-term solution, such as reconfiguring the distribution of assets across different electrical circuits or upgrading the capacity of the electrical circuit 436 of the group exhibiting the issue. In some embodiments, based on the configuration of the system 300, the system 300 may determine and implement the corrective actions without input from the manager of the premises 102. For example, if the temperature of the electrical socket 424 exceeds a critical threshold, the system 300 may automatically cut power to the electrical socket 424.

In an example, as indicated in step 518, the system 300 may then execute these corrective actions by sending an instruction 520 to the central hub 110 which may implement the corrective actions by regulating the operating parameters of the electrical sockets 106-1, 106-2, . . . , and 106-N, such as the electrical socket 424.

In an example, to execute the corrective actions suggested by the system 300, the central hub 110 may operate an actuator connected to the electrical socket, such as the actuator 116-1, to modify the operating parameters of the corresponding electrical socket, such as the electrical socket 424, in accordance with the corrective action. In another example, the system 300 may operate the actuator 116-1 directly to modify the operating parameters of the electrical socket 424 in accordance with the suggested corrective actions.

In an embodiment, the system 300 may display, for example, on the device 512 or a monitor in the control room of the premises 102, a visual representation of the configuration of the group. In an example, the visual representation may include a graphical layout of the electrical sockets in their respective zones.

Accordingly, the present subject matter provides for suggesting and implementing corrective actions to maintain the operation of the electrical sockets and their connected assets within safe and efficient parameters. This proactive approach ensures the safety and longevity of the electrical infrastructure and connected assets.

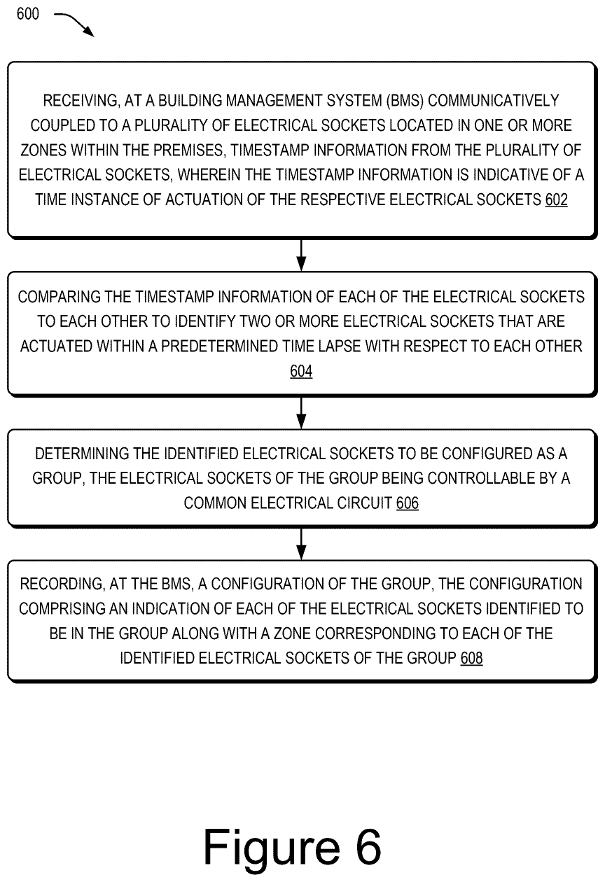

FIG. 6 illustrates a flowchart of method 600 for grouping of electrical sockets, such as the electrical sockets 106-1, 106-2, . . . , and 106-N, installed in a premises, such as the premises 102, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer-readable medium. The non-transitory computer-readable medium may include, for example, digital memories, magnetic storage media, such as magnetic disks and magnetic tapes, hard drives, or optically readable digital data storage media. In an example, the method 600 may be performed by the system 300.

Referring to FIG. 6, at block 602, timestamp information from each of the plurality of electrical sockets 106-1, 106-2, . . . , and 106-N may be received, for example, at the system 300. In an example, the system 300 may be a building management system (BMS). This BMS may be similar to the one explained previously in respect of FIGS. 1-2. The system 300 may be communicatively coupled to each of the plurality of electrical sockets 106-1, 106-2, . . . , and 106-N that may be located in one or more zones within the premises 102. In an example, the timestamp information may be indicative of a time instance of actuation of the respective electrical sockets 106-1, 106-2, . . . , and 106-N. This actuation may refer to when each electrical socket 106-1, 106-2, . . . , and 106-N comes online the BMS or is powered on. The timestamp information may include the date and time, when each electrical socket 106-1, 106-2, . . . , and 106-N becomes active. In an example, the timestamp information may be generated by internal clocks within the electrical sockets 106-1, 106-2, . . . , and 106-N or by the central hub 110 upon detecting the activation of each electrical socket 106-1, 106-2, . . . , and 106-N, for example, based on input from the sensors 108-1, 108-2 . . . 108-N connected to the respective electrical sockets 106-1, 106-2, . . . , and 106-N.

In an example, the timestamp information recorded by the central hub 110 may be transmitted to the system 300, for example, over the network 114. In an alternative embodiment, as explained previously, the system 300 may be directly connected to the electrical sockets 106-1, 106-2, . . . , and 106-N and may receive the timestamp information directly from each electrical socket 106-1, 106-2, . . . , and 106-N.

At block 604, the timestamp information of each electrical sockets 106-1, 106-2, . . . , and 106-N may be compared, for example, by the system 300, to each other to identify two or more electrical sockets from amongst the plurality of electrical sockets 106-1, 106-2, . . . , and 106-N that are actuated within a predetermined time lapse with respect to each other.

As explained previously, this comparison may involve sorting the timestamps information chronologically and then analyzing the time differences between consecutive electrical socket activations. In an example, the system 300 may employ various algorithms to perform this comparison efficiently, such as using a sliding window technique or a hash-based approach for identification of time-proximate events. In an example, the predetermined time lapse may be configurable to account for slight delays in actuation of the electrical sockets, for example, due to delay in power propagation through an electrical circuit. For instance, the predetermined time lapse may be configured based on user input.

At block 606, the electrical sockets that are identified to be actuated within the predetermined time lapse with respect to each other may be configured as a group, for example, by the system 300. In an example, the electrical sockets of the group may be controllable by a common electrical circuit.

At block 608, a configuration of the group may be recorded, for example, at the system 300. In an example, the configuration of the group may include an indication of each of the electrical sockets identified to be in the group along with a zone corresponding to each of the identified electrical sockets of the group. In an example, recording the configuration of the group may involve creating a logical association of the group within the memory 306 of the system 300, assigning a unique identifier to the group, and storing relevant metadata such as creation time of the group, identifiers of the member electrical sockets, and physical location of the electrical sockets of the group within the premises 102. The system 300 may also generate a visual representation of the group, such as a circuit diagram or a floor plan overlay, to aid in management and troubleshooting. The visual representation of the group may be displayed in a control room of the premises in an example. Once grouped, the electrical sockets may be treated as a single unit for various management tasks, including power monitoring, load balancing, and scheduled operations.

The system 300 may also implement safeguards to prevent overloading the common electrical circuit by monitoring the cumulative power draw of the electrical sockets in the group. Additionally, the grouping information may be used to optimize energy distribution, identify potential wiring issues, and facilitate maintenance procedures.

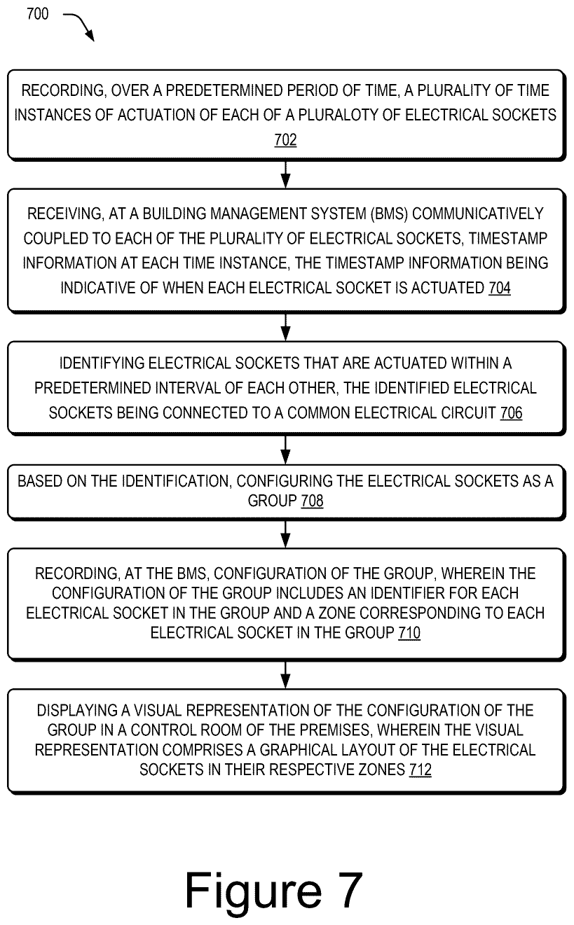

FIG. 7 illustrates a flow diagram of a process 700 for displaying a visual representation of a configuration of a group of electrical sockets, such as the electrical sockets 106-1, 106-2, . . . , and 106-N, according to an example implementation of the present subject matter. The order in which the above-mentioned process is described is not intended to be construed as a limitation, and some of the described process blocks may be combined in a different order to implement the process, or an alternative process.

Furthermore, the above-mentioned process may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 700 may be implemented by the system 112, and 300 of FIGS. 1, 2, and 3.

At block 702, time instances of actuation of each of the plurality of electrical sockets 106-1, 106-2, . . . , and 106-N installed in the premises 102 may be monitored, for example, by the system 300, over a predetermined duration. The predetermined duration for monitoring may be configurable and may range from a few minutes to several hours or even days, depending on the size and complexity of the premises 102.

At block 704, based on the monitoring, timestamp information corresponding to actuation events of each electrical socket 106-1, 106-2, . . . , and 106-N during the predetermined duration may be received, for example, by the system 300. This timestamp information may include the date and time of each actuation event of each of the plurality of electrical sockets 106-1, 106-2, . . . , and 106-N over the predetermined duration to accurately capture the moments of actuation of the electrical sockets. In an example, the timestamp information may be collected, for example, based on reading from the respective sensors 108-1, 108-2, . . . 108-N. The system 300 may store this timestamp information in the memory 306 for subsequent analysis and grouping operations.

At block 706, electrical sockets from amongst the plurality of electrical sockets 106-1, 106-2, . . . , and 106-N, that are actuated within a predetermined interval of each other, may be identified. Thus, it is determined that the electrical sockets so identified are connected to a common electrical circuit. This identification process is based on the principle that electrical sockets on the same electrical circuit typically actuate simultaneously or within a very short time frame of each other when power is restored after an outage or when a circuit breaker is reset. The system 300 may analyze the collected timestamp information of each electrical socket 106-1, 106-2, . . . , and 106-N collected over the predetermined interval to identify patterns of near-simultaneous actuation. The predetermined interval for considering electrical sockets as “actuated together” may be configurable to account for minor variations in electrical socket response times or data transmission delays.

At block 708, similar to the steps performed at step 606 of the method 600, based on the identification of the electrical sockets that are connected to the common electrical circuit, such identified electrical sockets may be configured as a group, for example, by the system 300 in the memory 306 of the system 300.

At block 710, similar to the steps performed at step 608 of the method 600, a configuration of the group may be recorded for example, at the system 300.

At block 712, a visual representation of the configuration of the group may be displayed, for example, in a control room of the premises 102. In an example, the visual representation may include a graphical layout of the electrical sockets in their respective zones.

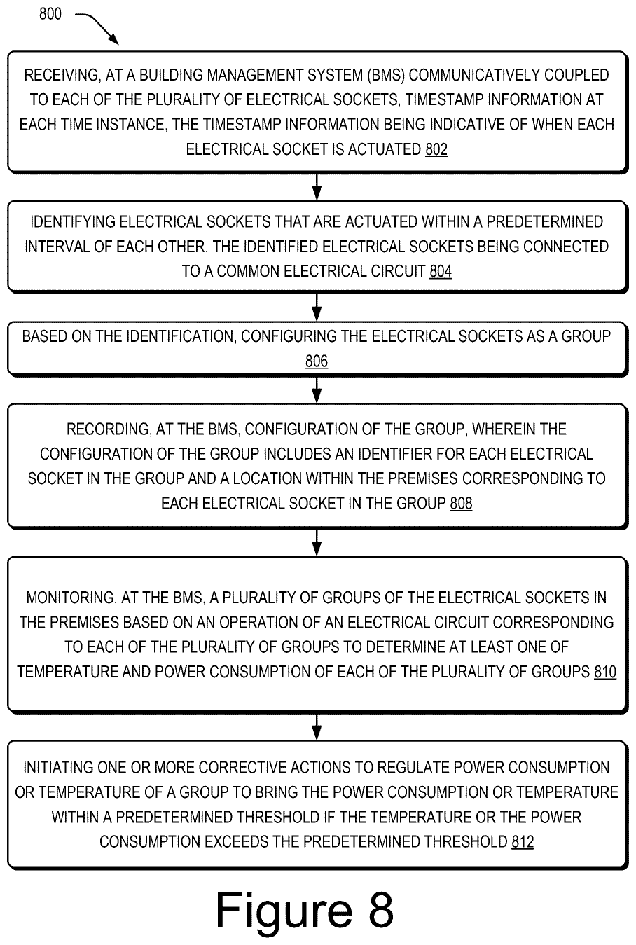

FIG. 8 illustrates a process 800 of monitoring a group of electrical sockets, such as the electrical sockets electrical sockets 106-1, 106-2, . . . , and 106-N, according to an example implementation of the present subject matter. The order in which the above-mentioned process is described is not intended to be construed as a limitation, and some of the described process blocks may be combined in a different order to implement the process, or an alternative process.

Furthermore, the above-mentioned process 800 may be implemented in a suitable hardware, computer-readable instructions, or a combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 800 may be implemented by the system 112, and 300 of FIGS. 1, 2, and 3.

Referring to FIG. 800, at block 802, similar to the steps performed at blocks 602 and 704 of the methods 600 and 700, respectively, timestamp information for each actuation instance of the electrical sockets 106-1, 106-2, . . . , and 106-N may be received by the system 300, for example, at the system 300.

At block 804, similar to the steps performed at blocks 604 and 706 of the methods 600 and 700, respectively, electrical sockets that are actuated within a predetermined interval of each other may be determined, for example, by the system 300. In an example, the identified electrical sockets may be connected to a common electrical circuit.

At block 806, similar to the steps performed at blocks 608 and 710 of the methods 600 and 700, respectively, configuration of the group may be recorded, for example, at the system 300. In an example, the configuration of the group may include an identifier for each electrical socket in the group and a zone corresponding to each electrical socket in the group.

At block 810, a plurality of groups of the electrical sockets that are configured in the system 300 may be monitored, for example, by the system 300. The monitoring may be performed based on the operation of an electrical circuit corresponding to each of the plurality of groups to determine at least one of temperature and power consumption of each of the plurality of groups. This monitoring process may involve real-time data collection from sensors integrated into each socket or from smart meters connected to the circuit. For example, in a group of electrical sockets designated as “Office Area Circuit 1,” the system 300 may monitor the power consumption of each electrical socket. An electrical socket A may show a constant draw of 50 watts, indicating a computer in sleep mode, while an electrical B may fluctuate between 200 and 400 watts, suggesting a printer in active use. Simultaneously, the system 300 may monitor the temperature at each electrical socket of the group.

At block 812, one or more corrective actions may be initiated, for example, by the system 300, to regulate power consumption or temperature to bring the power consumption and temperature within a predetermined threshold if at least one of the temperature and the power consumption exceeds the predetermined threshold. For example, referring to the previous example, if the system 300 determines that electrical socket C of the group of electrical sockets designated as the “Office Area Circuit 1” suddenly shows a temperature spike to 50° C. while drawing 300 watts, the system 300 may identify this as an overloading issue or a malfunctioning asset, prompting the system 300 to generate a recommendation. For example, a recommendation generated by the system 300 may include, but are not limited to, reduction in power to the electrical socket C, load redistribution to nearby electrical sockets, disconnecting of non-essential assets, inspect the connected assets. In an example, the recommendations generated by the system 300 may be executed either based on confirmation from the manager of the premises or without confirmation based on configuration of the system 300.

Thus, monitoring the grouped electrical sockets may help improve energy efficiency, enhance safety through quick detection of overloads or temperature anomalies, simplify troubleshooting, optimize load balancing, and facilitate accurate energy cost allocation. This helps in the early identification of malfunctioning assets or electrical sockets, thereby extending the lifespan of the assets and electrical sockets.

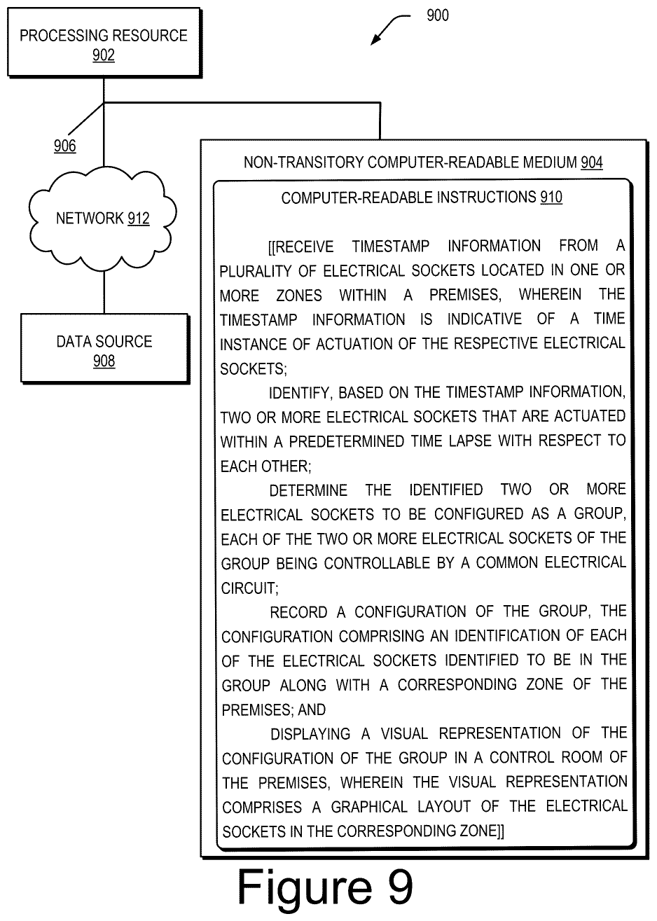

FIG. 9 illustrates a computing environment 900 for grouping of electrical circuits, such as the electrical circuits 106-1, 106-2, . . . , and 106-N, according to an example implementation of the present subject matter. In an example implementation, the computing environment 900 may comprise a computing device, such as the above-described system 112, 300. The computing environment 900 includes a processing resource 902 communicatively coupled to the non-transitory computer-readable medium 904 through a communication link 906.

In an example, the processing resource 902 may be a processor of the computing device, such as the processor 202 of the system 116, that fetches and executes computer-readable instructions from the non-transitory computer-readable medium 904.

The non-transitory computer-readable medium 904 can be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 can access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. In an example implementation, the non-transitory computer-readable medium 904 comprises executable instructions 910 for automatically grouping and monitoring electrical sockets in a premises, such as the premises 102. These operations are performed to efficiently manage power consumption, enhance safety, and optimize energy usage across various electrical circuits and zones within the premises 102.

In an example, the instructions 910 cause the processing resource 902 to receive timestamp information from the plurality of electrical sockets 106-1, 106-2, . . . , and 106-N located in one or more zones within the premises 102. As explained previously, the timestamp information may be indicative of a time instance of actuation of the respective electrical sockets 106-1, 106-2, . . . , and 106-N.

In an example, after having received the timestamp information corresponding to the plurality of electrical sockets 106-1, 106-2, . . . , and 106-N, in an example, the instructions 910 may cause the processing resource 902 to compare the timestamp information of each of the plurality of electrical sockets 106-1, 106-2, . . . , and 106-N to identify two or more electrical sockets from amongst the plurality of electrical sockets 106-1, 106-2, . . . , and 106-N that are actuated within a predetermined time lapse with respect to each other.

In another example, the instructions 910 may cause the processing resource 902 to determine the identified two or more electrical sockets to be configured as a group. In an example, each of the two or more electrical sockets of the group may be controllable by a common electrical circuit. In yet another example, the instructions 910 may cause the processing resource 902 to record a configuration of the group. In an example, the configuration of the group may include an indication of each of the electrical sockets identified to be in the group along with a zone corresponding to each of the identified electrical sockets of the group. In another example, the instructions 910 may cause the processing resource 902 to display a visual representation of the configuration of the group in a control room of the premises 102. In an example, the visual representation may include a graphical layout of the electrical sockets in the corresponding zone.

In yet another example, the instructions 910 may cause the processing resource 902 to create sub-groups within the group. In an example, each sub-group may include a subset of the electrical sockets in the group that are located in the zone. In an example, the instructions 910 may cause the processing resource 902 to monitor each sub-group of the electrical sockets independently. For example, in an office building, a group of electrical sockets may be subdivided into areas for different types of printing equipment. One sub-group may include electrical sockets powering high-volume printers, while another sub-group may encompass electrical sockets connected to large-format plotters. The processing resource 902 may then monitor each sub-group independently, tracking power usage patterns specific to each type of equipment. This enables the detection of anomalies like a malfunctioning printer drawing excess power or the identification of peak usage times for plotters. By analyzing these distinct sub-groups, the processing resource 902 may optimize energy use, schedule maintenance more effectively, and even suggest load balancing between different types of printing equipment to improve overall efficiency and reduce strain on any single electrical circuit.

In an example, the instructions 910 may cause the processing resource 902 to monitor a plurality of groups of the electrical sockets in the premises 102 based on an operation of an electrical circuit corresponding to each of the plurality of groups. In an example, during monitoring the plurality of groups of the electrical sockets, the processing resource 902 may determine temperature at each electrical socket in each of the plurality of groups. In an example, the processing resource 902 may generate an alarm if the temperature exceeds a predetermined threshold.

In another example, during monitoring the plurality of groups of the electrical sockets, the processing resource 902 may determine power consumption of each electrical socket in each of the plurality of groups. In an example, the processing resource 902 may generate an alarm if the power consumption exceeds a predetermined threshold.

Thus, the present subject matter provides for automatic grouping and monitoring of electrical sockets in a premises. Although implementations of automatic grouping and monitoring of the electrical sockets have been described in a language specific to structural features and/or methods, it is to be understood that the appended claims are not necessarily limited to the specific features or methods described. Rather, the specific features and methods are disclosed as example implementations of automatically grouping and monitoring the electrical sockets in the premises.

1. A method for grouping electrical sockets installed in a premises, the method comprising:
receiving, at a building management system (BMS) communicatively coupled to a plurality of electrical sockets located in one or more zones within the premises, timestamp information from the plurality of electrical sockets, wherein the timestamp information is indicative of a time instance of actuation of the respective electrical sockets;
comparing the timestamp information of each of the electrical sockets to each other to identify two or more electrical sockets that are actuated within a predetermined time lapse with respect to each other;
determining the identified electrical sockets to be configured as a group, the electrical sockets of the group being controllable by a common electrical circuit; and
recording, at the BMS, a configuration of the group, the configuration comprising an indication of each of the electrical sockets identified to be in the group along with a zone corresponding to each of the identified electrical sockets of the group.

2. The method of claim 1, further comprising monitoring, at the BMS, a plurality of groups of the electrical sockets in the premises based on an operation of an electrical circuit corresponding to each of the plurality of groups.

3. The method of claim 2, wherein monitoring the plurality of groups of the electrical sockets comprises:
determining temperature at each electrical socket in each of the plurality of groups; and
generating an alarm if the temperature exceeds a predetermined threshold.

4. The method of claim 2, wherein monitoring the plurality of groups of the electrical sockets comprises:
determining power consumption of each electrical socket in each of the plurality of groups; and
generating an alarm if the power consumption exceeds a predetermined threshold.

5. The method of claim 1, further comprising:
within the group of the identified electrical sockets, creating a sub-group, wherein the sub-group comprises a subset of the electrical sockets in the group that are located in the zone.

6. The method of claim 5, further comprising monitoring power consumption of each sub-group of the electrical sockets independently.

7. The method of claim 1, further comprising recording, over a predetermined period of time, a plurality of time instances of actuation of each of the electrical sockets.

8. The method of claim 1, further comprising displaying a visual representation of the configuration of the group in a control room of the premises, wherein the visual representation comprises a graphical layout of the electrical sockets in their respective zones.

9. A system for grouping electrical sockets installed in a premises, comprising:
a processor configured to:
receive timestamp information from a plurality of electrical sockets located in one or more zones within the premises, wherein the timestamp information is indicative of a time instance of actuation of the respective electrical sockets;
compare the timestamp information of each of the plurality of electrical sockets to identify two or more electrical sockets that are actuated within a predetermined time lapse with respect to each other;
determine the identified two or more electrical sockets to be configured as a group, each of the two or more electrical sockets of the group being controllable by a common electrical circuit;
record a configuration of the group, the configuration comprising an indication of each of the electrical sockets identified to be in the group along with a zone corresponding to each of the identified electrical sockets of the group; and
monitor at least one of power consumption and temperature of each electrical socket of the group.

10. The system of claim 9, wherein the processor is further configured to generate an alarm if at least one of the power consumption and the temperature exceeds a predetermined threshold.

11. The system of claim 9, wherein the processor is further configured to create sub-groups within the group, each sub-group comprising a subset of the electrical sockets in the group.

12. The system of claim 11, wherein the processor is further configured to monitor at least one of the power consumption and the temperature of each sub-group of the electrical sockets independently.

13. The system of claim 9, wherein the processor is further configured to record, over a predetermined period of time, time of actuation of the respective electrical sockets at multiple instances.

14. The system of claim 9, wherein the processor is further configured to generate for display a visual representation of the configuration of the group, wherein the visual representation comprises a graphical layout of the electrical sockets in their respective zones.

15. The system of claim 9, wherein the predetermined time lapse is configurable based on user-input.

16. A non-transitory computer-readable medium comprising instructions executable by a processing resource to:
receive timestamp information from a plurality of electrical sockets located in one or more zones within a premises, wherein the timestamp information is indicative of a time instance of actuation of the respective electrical sockets;
identify, based on the timestamp information, two or more electrical sockets that are actuated within a predetermined time lapse with respect to each other;
determine the identified two or more electrical sockets to be configured as a group, each of the two or more electrical sockets of the group being controllable by a common electrical circuit;
record a configuration of the group, the configuration comprising an identification of each of the electrical sockets identified to be in the group along with a corresponding zone of the premises; and
displaying a visual representation of the configuration of the group in a control room of the premises, wherein the visual representation comprises a graphical layout of the electrical sockets in the corresponding zone.

17. The non-transitory computer-readable medium of claim 16, further comprising instructions executable by the processing resource to create sub-groups within the group, each sub-group comprising a subset of the electrical sockets in the group that are located in the zone and monitor each sub-group of the electrical sockets independently.

18. The non-transitory computer-readable medium of claim 16, further comprising instructions executable by the processing resource to monitor the group of the electrical sockets based on an operation of an electrical circuit corresponding to the group.

19. The non-transitory computer-readable medium of claim 18, further comprising instructions executable by the processing resource to monitor the group to:
determine temperature at each electrical socket in the group; and
generate an alarm if the temperature exceeds a predetermined threshold.

20. The non-transitory computer-readable medium of claim 18, further comprising instructions executable by the processing resource to monitor the group to:
determine power consumption of each electrical socket in the group; and
generate an alarm if the power consumption exceeds a predetermined threshold.
